(19) United States
(12) Patent Application Publication
(10) Pub. No.: US 2007/0206716 A1
(43) Pub. Date: Sep. 6, 2007

(54) PLASMA CONTAINMENT METHOD

(76) Inventors: W. Farrell Edwards, Logan, UT (US); Eric D. Held, Logan, UT (US)

Correspondence Address: Kunzler & McKenzie, 8 EAST BROADWAY, SUITE 600, SALT LAKE CITY, UT, 84111, US

(21) Appl. No.: 11/624,672

(22) Filed: Jan. 18, 2007

Related U.S. Application Data
(63) Continuation-in-part of application No. 10/804,520, filed on Mar. 19, 2004, now abandoned.
(60) Provisional application No. 60/456,832, filed on Mar. 21, 2003.

(51) Int. Cl. G21B 1/00

(52) U.S. Cl. 376/121

(57) ABSTRACT

A method for plasma containment comprises varying the system energy subject to Maxwell's equations, momentum moment equations, and adiabatic equations of state, without imposing a quasi-neutrality condition. In one embodiment, electrons are confined by magnetic forces and ions by internal, electrostatic forces that arise due to charge separation of the two fluids. In one embodiment, input parameters for the energy variation process are selected so as to satisfy a plasma beta parameter condition, thereby reducing the number of control variables by one. The radial scale length for cylindrically symmetric plasmas in one-dimensional equilibrium is characterized by the electron skin depth. Such plasmas can be confined as a high aspect ratio toroid having compact dimensions. Applications of the invention include neutron generation, x-ray generation, and power generation.

### PRIORITY APPLICATIONS

This application is a continuation-in-part of U.S. patent application Ser. No. 10/804,520, filed 19 Mar. 2004, titled “Systems and Methods of Plasma Containment,” incorporated herein by reference. Application Ser. No. 10/804,520, in turn, claims priority benefit of U.S. provisional patent application No. 60/456,832, filed 21 Mar. 2003, titled “A Method of Obtaining Design Parameters for a Compact Thermonuclear Fusion Device,” incorporated herein by reference.

### BACKGROUND

1. Field

The present teachings generally relate to the field of plasma containment and more particularly, to systems and methods for establishing a stable plasma in a relatively compact containment chamber.

2. Description of the Related Art

Nuclear fusion occurs when two relatively low mass nuclei fuse to yield a larger mass nucleus and reaction products. Because a substantial amount of energy is associated with the reaction products, controlled nuclear fusion research is an ongoing process with efficient power generation being one of the important goals. Secondary goals may include the production of neutrons or X rays, among other things. For fusion to occur, two nuclei need to interact at a nuclear level after overcoming the mutually repulsive Coulomb barrier. Different methods can be used to promote such an interaction.

One widely-used method of promoting the fusion process is to provide a volume of plasma having the fusable ions at sufficient density and temperature. Such a plasma needs to be contained sufficiently long enough to allow the fusion reaction to occur. Preferably, such a containment substantially isolates the plasma from the surrounding environment to reduce heat loss.

One way to contain the fusionable plasma is to use magnetic fields to “pinch” and restrict the plasma to certain volumes. One magnetic confinement design commonly referred to as a tokamak restricts the plasma in a donut shaped (toroid) volume. Because many conventional magnetically confined fusion devices are geared toward power production, confinement volumes are designed to be large. Consequently, such large devices and various supporting components can be prohibitively complex and/or expensive to operate in widespread applications.

### SUMMARY

The foregoing drawbacks can be overcome by a containment method that enhances stability. Such a plasma can be designed and operated by determining a stable energy state of the system without imposing a quasi-neutrality condition; a contained plasma that includes a substantial electrostatic field will contribute significantly to the stability of the plasma. Compact devices based on such contained plasmas can be used in different applications, such as a neutron generator, an X ray generator, and a power generator.

One aspect of the present teachings relates to a method for designing a plasma containment device, including generating a characterization of the energy of a plasma system having a distribution of electrons and a distribution of ions. The characterization includes an energy term associated with a bulk electrostatic field produced inside the plasma by dissimilarities between the distribution of electrons and the distribution of ions. The method further includes determining an equilibrium state associated with the characterization of the energy of the plasma system. The method further includes determining one or more plasma parameters associated with the equilibrium state.

In a further aspect, the present invention relates to a method of plasma containment, including providing a plasma system, comprising a plurality of charged first particles and a plurality of charged second particles, and creating a dissimilarity between the overall distributions of the first and second particles. In one embodiment, the method includes restricting the plasma to a first beta value, second beta value, and first particle skin depth, the first and second beta values depending on factors comprising average particle number density, average plasma temperature, and strength of a magnetic field established in the plasma. In one embodiment, the inverse of the first beta value is between approximately 0 and 30 and the inverse of the second beta value is between approximately 0 and 3, with a first particle skin depth of between 1 and 2 in a cylindrical configuration.

In a further aspect, the present invention relates to a method of plasma containment, including providing a plasma comprising a plurality of first particles and a plurality of second particles, confining the first particles substantially to a first volume, and confining the second particles substantially to a second volume, with the second volume being larger than and encompassing the first volume. In one embodiment, movement of the first particles creates an electric current, and confining the first particles substantially to the first volume comprises establishing a magnetic field in the plasma substantially perpendicular to the direction of the current. In a further embodiment, confining the second particles substantially to the second volume comprises separating the bulk distributions of the first particles and the second particles such that a bulk electrostatic field is created in the plasma between the first particles and the second particles.

In a further aspect, the present invention relates to a method of plasma containment, including providing a plasma comprising a plurality of charged first particles and a plurality of charged second particles, with the first particles establishing a current by acting as charge carriers in the plasma, and imposing a magnetic field on the plasma, the magnetic field being oriented substantially perpendicular to the current and acting on the first particles to create a dissimilarity in distributions between the first particles and the second particles within the plasma. In one embodiment, the first particles comprise electrons and the second particles comprise ions. In another embodiment, the first particles comprise ions and the second particles comprise electrons. In a further embodiment, the plasma is contained within a substantially cylindrical volume, the volume defining an axial direction and an azimuthal direction, which may constitute part of a toroid. The current may flow in a combined axial-azimuthal direction with the magnetic field oriented in a combined azimuthal-axial direction. The current flow and magnetic field may be oriented spirally.

In a further aspect, the present invention relates to a method of plasma containment, including providing a plasma comprising a plurality of charged first particles and a plurality of charged second particles, the first particles being charge carriers of a current in the plasma, establishing a magnetic field in the plasma that electromagnetically Co. influences the position of the first particles more than it influences the position of the second particles, confining the first particles substantially to a first volume under the influence of the magnetic field, and maintaining at least a portion of the second particles outside the first volume. The position of the first particles may be electromagnetically influenced through a screw pinch. A bulk electrostatic field may be established within the plasma, and confining the second particles to a second volume (the first volume being smaller than and contained within the second volume), under the influence of the bulk electrostatic field.

### BRIEF DESCRIPTION OF THE DRAWINGS

FIG. 1 shows a contained plasma having a bulk electrostatic field produced inside the plasma due to a difference in the spatial distributions of electrons and ions;

FIG. 2 shows one embodiment of a process for determining a steady-state equilibrium of the plasma having the bulk E-field;

FIG. 3 shows one embodiment of a contained plasma having a cylindrical symmetry such that the electron and ion densities depend on radial distance r from the Z axis;

FIG. 4A shows a Z-pinch containment of the cylindrically symmetric plasma of FIG. 3;

FIG. 4B shows a theta-pinch containment of the cylindrically symmetric plasma of FIG. 3;

FIG. 5 shows how a high aspect ratio toroidal containment may be estimated by a cylindrical geometry;

FIG. 6 shows one embodiment of an azimuthal magnetic field profile that provides a Z-pinching;

FIG. 7 shows one embodiment of a stable confinement of electrons by a magnetic force that substantially offsets forces due to E-field and pressure;

FIG. 8 shows one embodiment of a stable confinement of ions by an electrostatic force that substantially offsets a force due to pressure;

FIG. 9A shows one embodiment of a E-field profile that results from different spatial distributions of confined electrons and ions;

FIG. 9B shows the electron and ion distributions of FIG. 9A on a logarithmic scale;

FIG. 10 shows one embodiment of a temperature profile showing how heat loss to a containment wall located relatively close to the plasma can be reduced;

FIG. 11 shows one embodiment of a contour plot of a plasma parameter 1/α as a function of Y/Λₑ and temperature T;

FIG. 12 shows one embodiment of a magnetic field profile of an axially directed magnetic field that theta-pinches the plasma;

FIG. 13 shows examples of different electron and ion distributions in the theta-pinched plasma;

FIG. 14 shows an example of an E-field profile that results from the different electron and ion distributions of FIG. 13;

FIGS. 15A-C show various scales of plasma containment facilitated by electrostatic fields produced by separation of charges;

FIG. 15D shows one embodiment of an reversed plasma configuration where the ions are magnetically confined and the electrons are confined by an electrostatic field, wherein such a plasma can be scaled to an ion scale length that is substantially greater than the electron scale length;

FIGS. 16A and B show one embodiment of a Z-pinch plasma containment device that can yield different electron and ion distributions;

FIGS. 17A and B show one embodiment of a theta-pinch plasma containment device that can yield different electron and ion distributions;

FIG. 18 shows one embodiment of a device that can emit various outputs based on a plasma where ion confinement is facilitated by a substantial electrostatic field;

FIG. 19 shows an embodiment of a method of plasma containment according to the present invention;

FIG. 20 shows one embodiment of a tokamak-type containment device;

FIG. 21 shows another embodiment of a tokamak-type containment device;

FIG. 21A is a view along line A-A of FIG. 20;

FIG. 21B is a view along line B-B of FIG. 20;

FIG. 22 is a graph showing a profile of the inverse of a plasma toroidal beta value as a function of the inverse of a plasma poloidal beta value;

FIG. 23 is a collection of graphs showing the profile of various plasma parameters as a function of time, first in a tokamak-like containment state, second in the minimum-energy containment state of the present invention.

These and other aspects, advantages, and novel features of the present teachings will become apparent upon reading the following detailed description and upon reference to the accompanying drawings. In the drawings, similar elements have similar reference numerals.

### DETAILED DESCRIPTION OF SOME EMBODIMENTS

The present teachings generally relate to systems and methods of plasma confinement at a relatively stable equilibrium. In one aspect, such a plasma includes a substantial internal electrostatic field that facilitates the stability and confinement of the plasma.

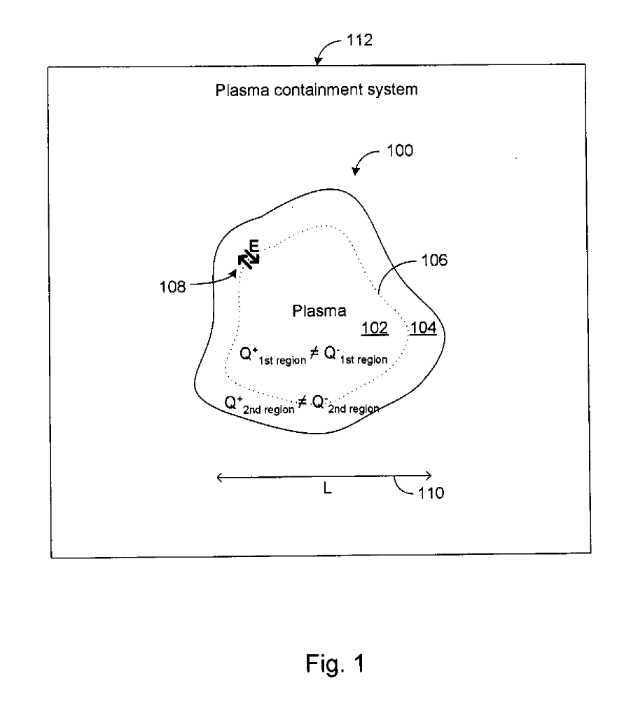

FIG. 1 shows a confined plasma 100 confined by a containment system 112. The plasma 100 defines a first region 102 substantially bounded by a boundary 106, and a second region 104 substantially bounded by the internal boundary 106 and the plasma's boundary. The plasma 100 has at least one dimension on the order of L as indicated by an arrow 110.

For the purpose of description, the plasma 100 can be characterized as a two-fluid system having an electron fluid (a fluid of a first particle species) and an ion fluid (a fluid of a second particle species). It will be understood that the ion fluid can involve one, two, or more species of ions based on the same or different elements and/or isotopes. It will also be understood that the collective fluid-equation of characterization of the plasma herein is simply one way of describing a plasma, and is in no way intended to limit the scope of the present teachings. A plasma can be characterized using other methods, such as a kinetic approach, as will be apparent to those skilled in the art in light of this disclosure.

As shown in FIG. 1, the plasma 100 is depicted as being in an internally non-quasi-neutral stable state, where in the first region 102, the integrated charge due to electrons Q⁻_{first region} is different than the integrated charge due to ions Q⁺_{first region}. Similarly in the second region 104, Q⁻_{second region} is significantly different than Q⁺_{second region}. The excess charge in the first region 102 is of opposite sign and is approximately equal in magnitude to the excess charge in the second region 104, thereby making the plasma 100, as a whole, substantially neutral.

As further shown in FIG. 1, the formation of excess charges of different signs about the internal boundary 106 causes a formation of a bulk internal electrostatic field depicted as arrows 108. If one uses a convention where an E-field points away from a positive charge and towards a negative charge, the E-field 108 would point inward about the boundary 106 if the first region 102 has excess electrons (and the second region 104 has excess ions). Conversely, the E-field 108 would point outward about the boundary 106 if the first region 102 has excess ions. Both possibilities are described below in greater detail.

As described herein, formation of such electrostatic fields within the plasma 100 contributes to the energy of the plasma system. Determining a relatively-stable energy state of such a system yields plasma parameters, including selected ranges of a plasma dimension L, that are substantially different than that associated with conventional plasma systems. It is generally known that static electric fields in a plasma typically do not exist over a distance substantially greater than the Debye length. They are shielded out because of rearrangements of electrons and ions. This, however, is in the absence of external forces. In the present disclosure described herein, the plasma dimension L is generally greater than many Debye lengths; however this is permitted because of the presence of external forces due to, for example, presence of magnetic fields.

In the description below, various embodiments of plasma systems are described as cylindrical and toroidal systems. In the present disclosure a cylindrical geometry is used for a simplified description, and is not to be construed as limiting in any manner. Because at least some of the effects described herein depend on the scale of the contained plasma, many arbitrary shapes of a contained plasma can be used in connection with the present disclosure. As an example, the plasma 100 in FIG. 1 is depicted as a “generic” shaped volume manifesting the internal electrostatic field effect by being contained appropriately at a scale on the order of L and given the associated plasma parameters.

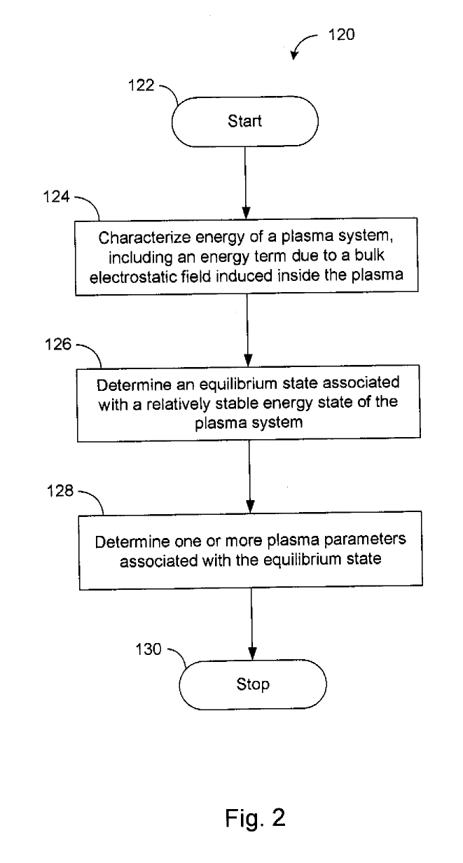

One aspect of the present teachings relates to a method for determining a plasma state that is relatively stable and wherein such stability is facilitated by formation of a relatively substantial internal electrostatic field. FIG. 2 shows one embodiment of a process 120 that determines such a stable state and one or more associated plasma parameters. The process 120 begins at a start state 122, and in a process block 124 that follows, the process 124 characterizes an energy of a plasma system. The energy characterization includes an energy term due to a substantial electrostatic field produced inside the plasma. In a process block 126 that follows, the process 120 determines an equilibrium state associated with a relatively stable energy state of the plasma system. In a process block 128 that follows, the process 120 determines one or more plasma parameters associated with the equilibrium state. The process 120 ends in a stop state 130.

One way to characterize the energy of the plasma system is to use a two-fluid approach without the quasi-neutrality assumption. In conventional approaches, quasi-neutrality is assumed such that electron and ion density distributions are substantially equal. In contrast, one aspect of the present teachings relates to characterizing the two-fluid system such that the electron and ion densities are allowed to vary independently substantially throughout the plasma. Such an approach allows the two fluids to be distributed differently, and thereby produce a bulk electrostatic field at an equilibrium state of the plasma.

For a plasma contained at least partially by a magnetic field, the energy U of the system can be expressed as an integral of a sum of an E-field energy term, a B-field energy term, kinetic energy terms of the two fluids, and energy terms associated with pressures of the two fluids. Thus,

$$U = \int [ \frac{{ɛ}_{0} {E}^{2}}{2} + \frac{{B}^{2}}{2 {μ}_{0}} + {\sum }_{s} ( \frac{{m}_{s} {n}_{s}}{2} {u}_{s}^{2} + {p}_{s} ) ] ⅆ V \qquad ( 1 )$$

where E represents the electric field strength, ε₀ represents the permittivity of free space, B represents the magnetic field strength, μ₀ represents the permeability of free space, the summation index and subscripts s denote the species electrons e or ions i, mₛ represents the mass of the corresponding species, nₛ represents the particle density of the corresponding species, uₛ represents the velocity of the corresponding species, pₛ represents the pressure of the corresponding species fluid, and dV represents the differential volume element of the volume of plasma.

For the purpose of description herein, it will be understood that terms “particle density,” “number density,” and other similar terms generally refer to a distribution of particles. Terms such as “electron density” and “electron number density” generally refer to a distribution of electrons. Terms such as “ion density” and “ion number density” generally refer to a distribution of ion. Furthermore in the description herein, terms such as “average particle density” and “average number density” are used to generally denote an average value of the corresponding distribution.

One way to further characterize the two-fluid plasma of this example is to treat the system as being a substantially collisionless and substantially fully-ionized plasma in a steady-state equilibrium. Moreover, each species of the two fluids can be characterized as substantially obeying an adiabatic equation of state expressed as
pₛ=Cₛnₛ^{γ} (2)
where the Cₛ represents a constant that can be substantially determined by a method described below, and γ represents the ratio of specific heats of the two species.

Temperatures associated with the two species can be determined through an ideal gas law relationship
pₛ=nₛkTₛ (3)
where k represents the Boltzmann's constant. Furthermore, both species are assumed to be substantially Maxwellian.

One way to further characterize the plasma is to express, for each species, a substantially collisionless, equilibrium force balance equation as
mₛnₛ(uₛ·∇)uₛ=qₛnₛ(E+uₛ×B)−∇pₛ (4)
where mₛ represents the particle mass of species s, qₛ represents the charge, uₛ represents the fluid velocity, and where the anisotropic part of the stress tensor can be and is ignored for simplicity for the purpose of description.

One way to further characterize the plasma is to express, for the system, Maxwell's equations as

$$\begin{matrix}∇ \cdot E = {\sum }_{s} {q}_{s} {n}_{s} / {ɛ}_{0} ; & ( 5 ) \\ ∇ \times B = {μ}_{o} {\sum }_{s} {q}_{s} {n}_{s} {u}_{s} ; & ( 6 ) \\ ∇ \times E = 0 ; and & ( 7 ) \\ ∇ \cdot B = 0. & ( 8 )\end{matrix}$$

As is known, Equation (5) is one way of expressing Poisson's equation; Equation (6) is one way of expressing Ampere's law for substantially steady-state conditions; Equation (7) is one way of expressing the irrotational property of an electric field which follows from Faraday's Law for substantially steady-state conditions; and Equation (8) is one way of expressing the solenoidal property of a magnetic field.

As is also known, Maxwell's equations assume conservation of total charge of a system. Accordingly, one can introduce a dependent variable Q defined as
∇·Q=nₑ (9)
to substantially ensure electron conservation by adopting appropriate boundary conditions in a manner described below. The electron density nₑ can further be characterized as obeying a relationship nₑ≧0.

One way to determine a relatively stable confinement state of a plasma system is to determine an equilibrium state that arises from a first variation of the total energy of the plasma system as expressed in Equation (1) subject to various constraints as expressed in Equations (2)-(9). For the present invention, total energy may be defined as the combination of energy associated with pressure due to the temperature of the plasma particles, in this case ions and electrons, energy stored in the net electric field, energy stored in the net magnetic field, and kinetic energy associated with the movement of the plasma particles, in this case ions and electrons. In one such determination, the pressure term in Equations (1) and (4) can be eliminated by using Equation (2). The resulting constraints can be adjoined to the resulting energy expression U by using Lagrange multiplier functions. Such a variational procedure generally known in the art can result in a relatively complex general vector form of nonlinear differential equations.

One way to simplify the variational procedure without sacrificing interesting properties of the resulting solutions is to perform the procedure using cylindrical coordinates and symmetries associated therewith. The cylindrical symmetries can be used to reduce the independent variables of the system to one variable r. Accordingly, dependent variables of the system can be expressed as nᵢ, nₑ, Eᵣ, B_{z}, B_{θ}, Q, u_{iz}, u_{iθ}, u_{ez}, and u_{eθ}, where subscripts i and e respectively represent ion and electron species. The first six are state variables. Because derivatives of the last four (velocity components) do not appear in Equations (11A)-(11P) they can be treated as control variables in a manner described below.

Applying the cylindrical symmetries to the plasma system (where constraints ∇×E=0 and ∇·B=0 of Equations (7) and (8) are substantially satisfied identically), cylindrical coordinate expressions associated with Equations (4)-(6) and (9) can be adjoined to U of Equation (1) using Lagrange multiplier functions Mᵢ, Mₑ, M_{E}, M_{z}, M_{θ}, and M_{Q}. As the name implies, variations of the control variables may be considered as N 2 producing variations in the state variables as well as in the Lagrange multiplier functions.

The variation of U leads to first-order differential equations for the state variables and for the Lagrange multiplier functions, and to algebraic equations for the control variables. Such equations can conveniently be expressed as equations in dimensionless form using the following replacements: r→rΛₑ, uₛ→uₛc, n→N₀n, E→EeN₀Λₑ/ε₀, B→BeN₀Λₑ/μ₀c. Cₛ→Cₛmₑc²N₀^{1-γ}, pₛ→pₛmₑN₀c², Q→QΛₑ and T→Tₛk/mc², where c represents the speed of light, N₀ represents the average particle density, e represents the magnitude of the electron charge, and Λₑ represents the electron skin depth expressed as
Λₑ=(mₑ/μₒN₀e²)^{1/2}. (10)

One system of equations that follows from the foregoing energy variation method can be expressed as

$$\begin{matrix}ⅆ {M}_{e} / ⅆ r = - {ru}_{ez}^{2} / 2 - {M}_{θ} {u}_{ez} - {ru}_{e θ}^{2} / 2 + {M}_{z} {u}_{e θ} - {M}_{E} - {M}_{Q} - {C}_{e} r γ {n}_{e}^{γ - 1} - {{M}_{e} ( {C}_{e} γ )}^{- 1} ( 2 - γ ) {n}_{e}^{1 - γ} ( {E}_{r} + {u}_{e θ} {B}_{z} - {u}_{ez} {B}_{θ} + {u}_{w θ}^{2} / r ) & ( 11 A ) \\ ⅆ {M}_{i} / ⅆ r = - {ru}_{iz}^{2} / 2 - {M}_{θ} {u}_{iz} - {ru}_{i θ}^{2} / 2 + {M}_{z} {u}_{i θ} + {M}_{E} - {C}_{i} r γ {n}_{i}^{γ - 1} + {{M}_{i} ( {C}_{i} γ )}^{- 1} ( 2 - γ ) {n}_{i}^{1 - γ} ( {E}_{r} + {u}_{i θ} {B}_{z} - {u}_{iz} {B}_{θ} + {u}_{i θ}^{2} / r ) & ( 11 B ) \\ ⅆ {M}_{E} / ⅆ r = - {rE}_{r} - {M}_{e} {{n}_{e}^{2 - γ} ( {C}_{e} γ )}^{- 1} + {M}_{i} {{n}_{i}^{2 - γ} ( {C}_{i} γ )}^{- 1} - {M}_{E} / r & ( 11 C ) \\ ⅆ {M}_{z} / ⅆ r = - {rB}_{z} - {M}_{e} {n}_{e}^{2 - γ} {{u}_{e θ} ( {C}_{e} γ )}^{- 1} + {M}_{i} {n}_{i}^{2 - γ} {{u}_{i θ} ( {C}_{i} γ )}^{- 1} & ( 11 D ) \\ ⅆ {M}_{θ} / ⅆ r = - {rB}_{θ} + {M}_{e} {n}_{e}^{2 - γ} {{u}_{ez} ( {C}_{e} γ )}^{- 1} - {M}_{i} {n}_{i}^{2 - γ} {{u}_{iz} ( {C}_{i} γ )}^{- 1} + {M}_{θ} / r & ( 11 E ) \\ ⅆ {M}_{Q} / ⅆ r = {M}_{Q} / r & ( 11 F ) \\ {u}_{ez} = \{ {M}_{e} {n}_{e}^{1 - γ} {{B}_{θ} ( {C}_{e} γ )}^{- 1} - {M}_{θ} \} / r & ( 11 G ) \\ {u}_{e θ} = \{ {M}_{z} - {M}_{e} {{n}_{e}^{1 - γ} ( {rC}_{e} γ )}^{- 1} \} / \{ r + 2 {M}_{e} {{n}_{e}^{1 - γ} ( {rC}_{e} )}^{- 1} \} & ( 11 H ) \\ {u}_{iz} = \{ {M}_{i} {n}_{i}^{1 - γ} {{B}_{θ} ( {C}_{i} γ )}^{- 1} - {M}_{θ} \} / r & ( 11 I ) \\ {u}_{i θ} = \{ {M}_{z} - {M}_{i} {n}_{i}^{1 - γ} ( {rC}_{i} {γ}^{- 1} ) \} / \{ r + 2 {M}_{i} {{n}_{i}^{1 - γ} ( {rC}_{i} )}^{- 1} \} & ( 11 J ) \\ ⅆ {n}_{e} / ⅆ r = - {( {C}_{e} γ )}^{- 1} {n}_{e}^{2 - γ} ( {E}_{r} + {u}_{e θ} {B}_{z} - {u}_{ez} {B}_{θ} - {u}_{e θ}^{2} / r ) & ( 11 K ) \\ ⅆ {n}_{i} / ⅆ r = {( {C}_{i} γ )}^{- 1} {n}_{i}^{2 - γ} ( {E}_{r} + {u}_{i θ} {B}_{z} - {u}_{oz} {B}_{θ} + {u}_{i θ}^{2} / r ) & ( 11 L ) \\ ⅆ {E}_{r} / ⅆ r = - {E}_{r} / r + {n}_{i} - {n}_{e} & ( 11 M ) \\ ⅆ {B}_{z} / ⅆ r = {n}_{e} {u}_{e θ} - {n}_{i} {u}_{iz} - {n}_{e} {u}_{ez} & ( 11 N ) \\ ⅆ {B}_{θ} / ⅆ r = - {B}_{θ} / r + {n}_{i} {u}_{iz} - {n}_{e} {u}_{ez} & ( 11 O ) \\ ⅆ Q / ⅆ r = - Q / r + {n}_{e} & ( 11 P )\end{matrix}$$

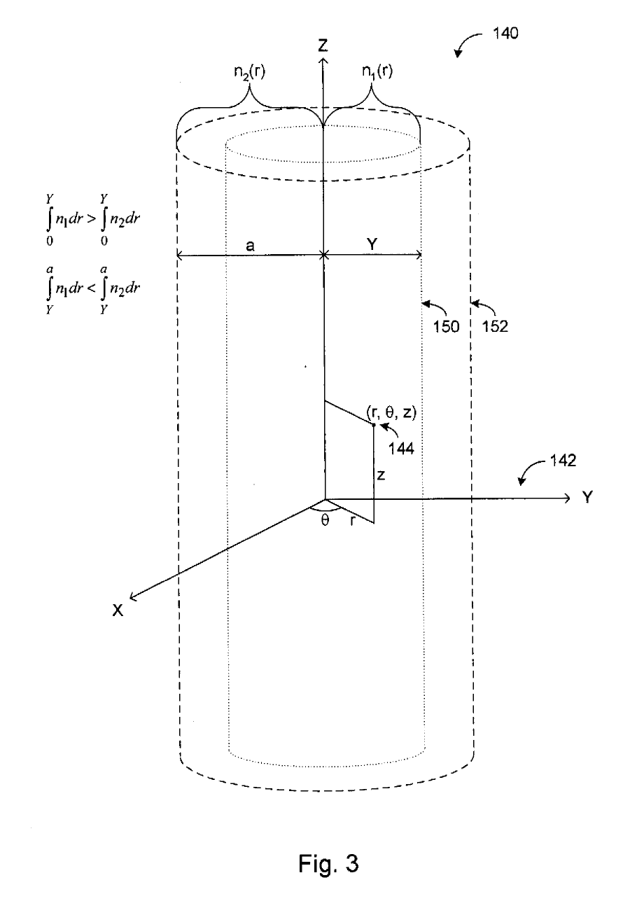

One set of boundary conditions (at r=0 and r=a, where a is defined as an outer boundary in FIG. 3) includes Eᵣ(0)=Eᵣ(a)=0, B_{z}(a)=B₀, and B_{θ}(0)=0. Boundary conditions can further include Q(0)=0 and Q(a)=N₀a/2 relating to charge conservation for individual species. Conditions at each boundary can further be imposed on each state variable or its corresponding Lagrange multiplier function so as to be substantially equal to zero if there is substantially no state-variable condition. It follows that Mₑ(0)=Mₑ(a)=Mᵢ(0)=Mᵢ(a)=M_{z}(0)=0.

In one implementation of a method for determining a stable equilibrium of the foregoing cylindrical plasma system, input parameters (expressed in dimensional form) for solving the system of equations (Equations (11A-P)) include the cylindrical radius a, the average particle number density N₀ substantially equal for both species, the axial magnetic field at the boundary a such that B_{z}(a)=B₀, the net axial current I, and a temperature value T₀ for both electrons and ions that is the temperature taken at that value of r at which nₛ=N₀. Using these input parameters, one can determine that B_{θ}(a)=μ₀I/(2πa).

Furthermore, the values of Cₛ can be determined by combining the adiabatic equation of state from Equation (2) and the ideal gas law from Equation (3) so as to yield Cₛ=nₛ^{1-γ}kT₀. Thus, Cₛ=N₀^{1-γ}kT₀ when evaluated at the value of r where nₛ=N₀ and Tₛ=T₀. The electron and ion average temperatures may be different, which would result in different values of Cᵢ and Cₑ. For the examples of the present disclosure, they are taken to be substantially the same, i.e., T₀. Such a simplification for the purpose of description should not be construed to limit the scope of the present teachings in any manner.

Another useful set of input parameters can be obtained by replacing B₀ with a plasma beta value defined as β=N₀kT₀/(B₀²/2μ₀) (in the geometry of FIG. 3, an azimuthal beta value) and by replacing I with another beta value α=N₀kT₀/(B_{θ}(a)²/2μ₀) (in the geometry of FIG. 3, an axial beta value), where I=2πaB_{θ}(a)/μ₀. Note that 1/β=0 corresponds to a substantially pure Z-pinch, and 1/α=0 corresponds to a substantially pure theta-pinch. A screw-pinch corresponds to substantially nonzero values for both 1/α and 1/β.

The foregoing energy variational method yields a description of the plasma system by twelve first-order coupled nonlinear ordinary differential equations, four algebraic equations, and one inequality condition (nₑ≧0), with sixteen unknowns. Numerical solutions to such a system of equations can be obtained in a number of ways. Solutions disclosed herein are obtained using a known differential equation solving routine such as BVPFD that is part of a known numerical analysis software IMSL.

FIG. 3 now shows one embodiment of a cylindrically shaped contained plasma 140 that embodies a possible solution to the energy variation analysis of the two-fluid system described above. As a reference, the cylindrical plasma 140 is superimposed with a cylindrical coordinate system 142. An arbitrary point 144 on the coordinate system 142 can be expressed as having coordinates (r, θ, z).

The plasma 140 defines a first cylindrical volume 150 extending from the Z-axis to r=Y, and a second cylindrical volume 152 extending from the Z-axis to r=a. The first volume 150 generally corresponds to a region of the plasma 140 where the first species of the two fluids is distributed as n₁(r). The second volume 152 generally corresponds to a region of the plasma 140 where the second species of the two fluids is distributed as n₂(r).

In general, the first and second species are distributed such that

$$\begin{matrix}{\int }_{0}^{Y} {n}_{1} ⅆ r > {\int }_{0}^{Y} {n}_{2} ⅆ r , & ( 12 A ) \\ {\int }_{0}^{a} {n}_{1} ⅆ r = 0 , & ( 12 B ) \\ {\int }_{0}^{a} {n}_{1} ⅆ r = {\int }_{0}^{a} {n}_{2} ⅆ r . & ( 12 C )\end{matrix}$$

That is, the first region 150 has more of the first species than the second species, and the portion of the second region 152 outside of the first region has substantially none of the first species. As Equation (12C) shows, the total number of particles in the two species is substantially the same in one embodiment.

In some embodiments, substantially all of the first species is located within the first region 150 such that r=Y defines a boundary for the first species. Consequently, the region Y<r<a has substantially none of the first species, and is populated by the second species by an amount ΔN. Since the total numbers of the first and second species are substantially the same in one embodiment, the value of ΔN is also representative of the excess number of the first species relative to the second species in the first region 150.

In some embodiments, as described below in greater detail, the first species can be the electrons, and the second species the ions when a plasma is contained within one or more selected ranges of value for the boundary r=Y. In other embodiments, as also described below in greater detail, the first species can be the ions, and the second species the electrons when the plasma is contained in one or more other selected ranges of value for the boundary r=Y.

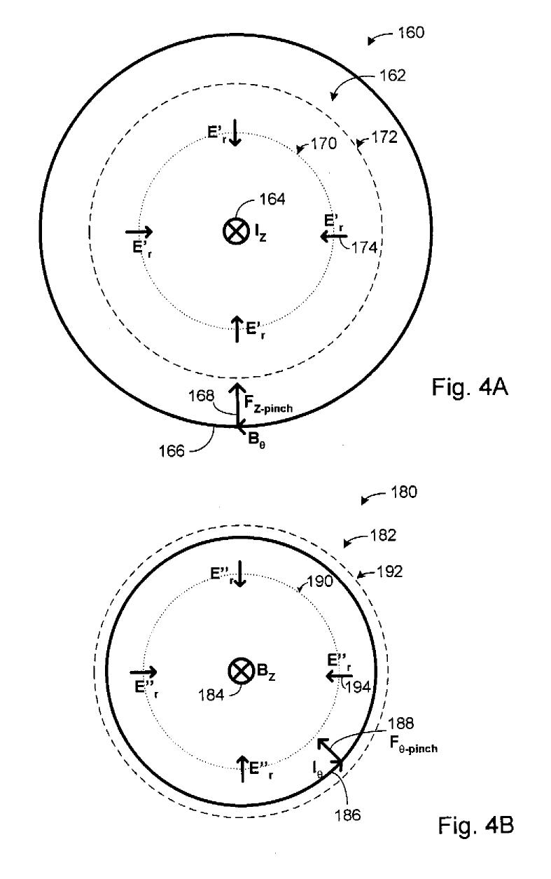

FIGS. 4A and B show two methods of confining a cylindrical geometry plasma by magnetic fields, thereby causing the electron and ion distributions to become different in a manner described above in reference to FIG. 3. FIG. 4A shows one embodiment of a Z-pinch confinement 160, and FIG. 4B shows one embodiment of a theta-pinch confinement 180. Although the Z-pinch and theta-pinch methods are shown separately, it will be understood that these two pinches can be combined to form what is commonly referred to as a screw-pinch.

As shown in FIG. 4A, the Z-pinch 160 can be achieved when an axial current I_{Z} 164 is established in a plasma 172. Such a current can be established in a number of ways, including an example method described below. The axial current I_{Z} 164 causes formation of an azimuthal magnetic field B_{θ} 166 that asserts a radially inward force F_{Z-pinch} 168 on the moving charged particles of the plasma 162.

As described below in greater detail, when the radial dimension of the plasma is selected in certain ranges, motion of one species relative to the other species can be enhanced and thereby be more subject to the magnetic pinching force. Thus, as shown in FIG. 4A, an inner first region 170 of the plasma 162 includes substantially all of the magnetically contained species. In FIG. 4A, the magnetically confined species is depicted as being the electrons. As such, the ions are distributed within a second region 172 that includes and radially extends beyond the first region 170. Such a distribution of the two N f species can produce a substantial internal electrostatic field 174 denoted as E′ᵣ. The electrostatic field 174 facilitates containment of the ions substantially within the second region 172. It will be understood that if the ions are made to be magnetically confined within the first region 170, the electrostatic field 174 is reversed in direction, and the electron confinement can be facilitated by such an electrostatic field.

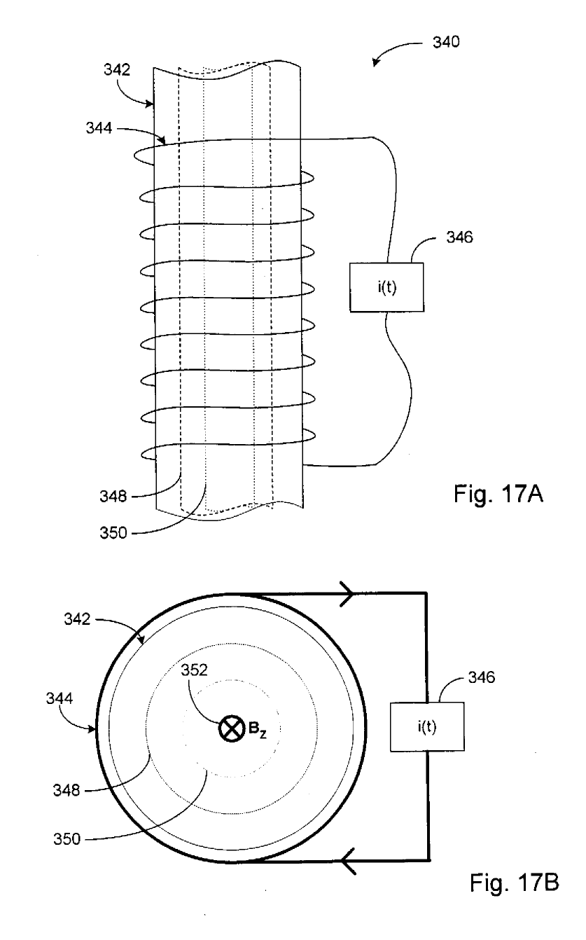

As shown in FIG. 4B, the theta-pinch 180 can be achieved when a steady azimuthal current I_{θ} becomes established in the plasma. The current I_{θ} 186 can be established through plasma relaxation from a high-energy state to the lower(minimum)-energy state as discussed below. The direction of magnetic field B_{Z} 184 in the figure may appear to be inconsistent with the direction of current I_{θ} 186; however, current in external field windings 344 (FIGS. 17A and 17B, discussed below) also contributes to the magnetic field B_{Z} 184. This externally-produced share of the magnetic field is stronger and in the opposite direction from that of the internal, plasma-produced portion of the field. The plasma current I_{θ} 186 thus reduces the magnitude of the total field 184. The axial magnetic field B_{Z} 184 asserts a radially inward force F_{θ-pinch} 188 on the azimuthal current I_{θ} 186 and thereby facilitates containment of the plasma 182.

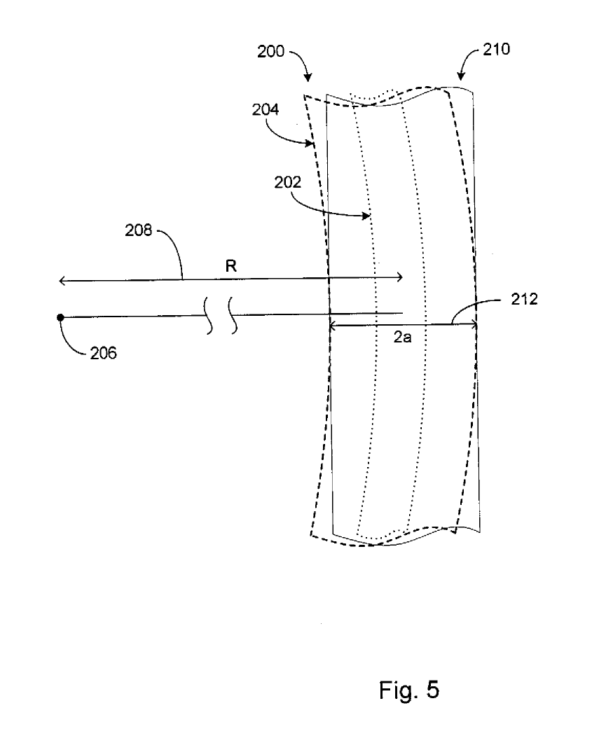

FIG. 5 now shows that a plasma confinement solution described above in the context of cylindrical geometry can be used to approximate a design of a toroidal geometry containment device. A section of a toroidally confined plasma 200 is shown superimposed with a section of a similarly dimensioned (tube dimension) cylindrically confined plasma 210. The toroid 200 is depicted to be centered about a center point 206 such that the center of the toroidal “tube” (having a radius a, known as the toroid's minor radius) is separated from the center point 206 by a distance R (indicated by arrow 208). As will be apparent to those skilled in the art in light of this disclosure, the axial component or direction of the cylindrically confined plasma 210 corresponds to a toroidal component or direction of the toroidally confined plasma 200, with the azimuthal component or direction of the plasma 210 corresponding to a poloidal component or direction of the plasma 200.

One can see that when the distance R is relatively large compared to a, such as in a high aspect ratio (R/a) toroid, a given segment of the toroid geometry can be approximated by the cylindrical geometry. Thus, one can obtain design parameters using a cylindrical geometry, and apply such a solution to designing of a toroidal device. As is known in the art, such a cylindrical approximation provides a good base for a toroidal design. One way to correct for the differences between the toroidal and cylindrical geometries is to provide a corrective external field, often referred to as a vertical field that inhibits the plasma toroid radius R from increasing due to magnetic hoop forces, to confine the plasma.

Thus as shown in FIG. 5, a toroidally confined plasma 200 includes a toroidally shaped first region 202 and a toroidally shaped second region 204 that are arranged with respect to each other in a manner similar to that of a cylindrical plasma. As with the cylindrical plasma, the first region may be defined by electrons in some embodiments, and also by ions in other embodiments.

The foregoing analysis of the cylindrical plasma includes a one-dimensional (r) analysis using the energy variation method. As described above in reference to FIG. 5, such one-dimensional analysis can provide a basis for estimating the design and characterization of a high aspect ratio toroid. A more generalized three-dimensional analysis of, for example, a general toroid or a chamber of any shape, in a similar manner is expected to yield similar results where parts of the electrons and ions separate, thereby causing a substantial electrostatic field within the plasma.

One aspect of the present teachings relates to a scale of a contained plasma having a substantial electrostatic field therein. Various results of the foregoing energy variational procedure are described in the context of cylindrical symmetry. It will be appreciated, however, that such results can also be manifested in other shapes of contained plasma having a similar scale.

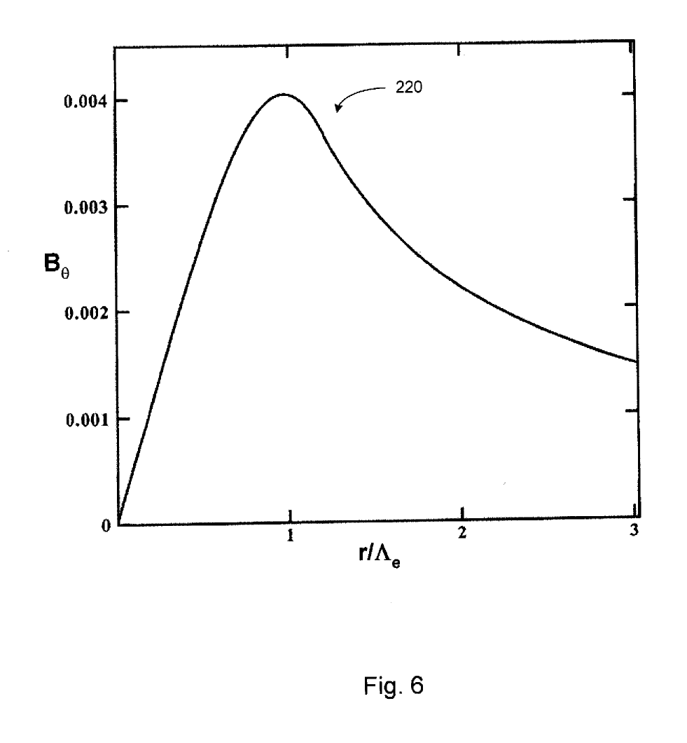

FIGS. 6-10 show various plasma parameters that result from the cylindrically symmetric energy variational analysis for a Z-pinched system with a set of inputs. The plasma is defined as a cylinder having an outer diameter a of approximately three times the skin depth (scale length) Λₑ. With such a selection of the scale of the plasma, example input parameters include N₀=10¹⁹/m³, T₀=5 keV, 1/α=2.51 (thereby defining the magnetic field strength B_{θ}(a) and the axial current I), and 1/β=0 (thereby setting B_{z}(a)=B₀=0). The corresponding electron skin depth parameter Λₑ=(mₑ/μₒN₀e²)^{1/2} (Equation (10), and depending on the input parameter N₀) is approximately 1.7 mm.

The foregoing input parameters result in a contained plasma where the electrons are pinched by magnetic forces thereby giving rise to electron-ion charge separation. Consequently, the electrons are distributed substantially within the inner region of the cylinder (first region 150 in FIG. 3), and the ions are distributed partially in the first region 150 and partially beyond the boundary (r=Y) of the first region 150. Such a charge separation produces a static electric field that confines the ions. The resulting charge gradient scale length is relatively small—on the order of the electron skin depth as expressed in Equation (10).

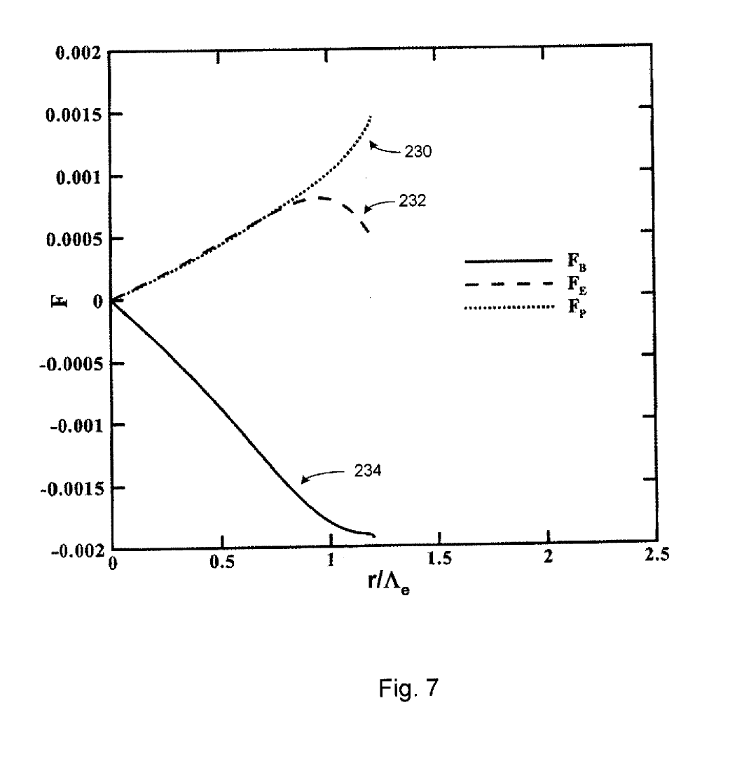

FIG. 6 shows a profile 220 of the azimuthal magnetic field strength B_{θ} as a function of a dimensionless variable r/Λₑ. Such a magnetic field confines the electrons as shown in FIG. 7, where the forces acting on the electrons are shown as a function of r/Λₑ. In the force profile of FIG. 7, a positive value of a force is indicative of a radially outward directionality, and a negative value the opposite. Thus, a kinetic pressure force 230 that tends to make the electron fluid want to expand is directed outward. An electrical force 232 on the electrons is caused by the inwardly directed electrostatic field produced in the plasma by the foregoing charge gradient. A magnetic force 234 that confines the electrons is thereby directly inward, and offsets the sum of outwardly directed pressure and electrical forces 230, 232 over much of the electron volume. In the example electron confinement shown in FIG. 7, the pressure and electrical forces 230 and 232 have substantially similar magnitudes over much of the electron volume. In one embodiment shown in FIG. 7, the electron forces profiles do not extend beyond r=Y because there are substantially no electrons beyond that boundary.

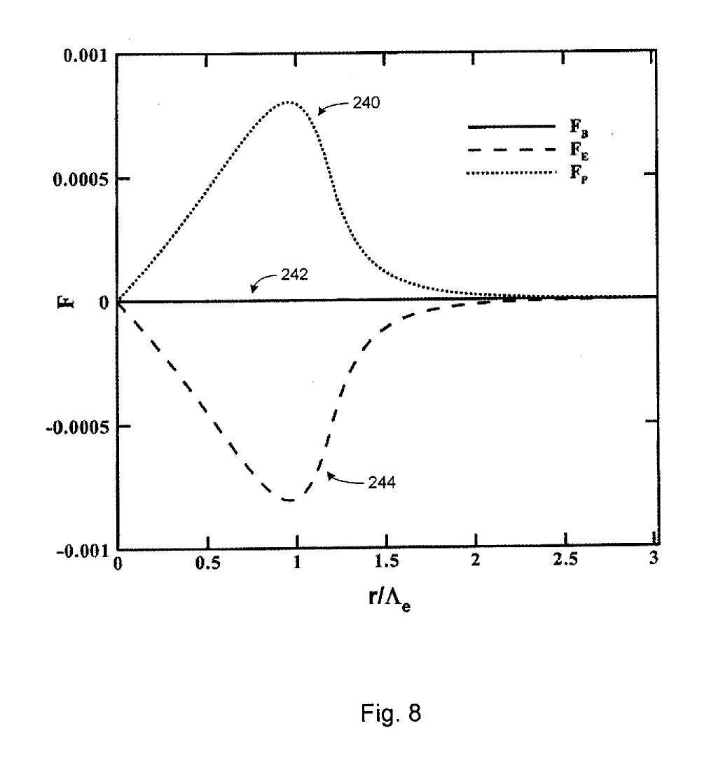

FIG. 8 shows profiles of forces acting on the ions. In electron mode, i.e., where the electrons are carrying the current, a magnetic force 242 on the ions is substantially negligible due to the relatively low velocity of the moving ions. A kinetic pressure force 240 that tends to make the ion fluid want to expand is directed outward. An electrical force 244 on the ions is directed inward, and is caused by the inwardly directed electrostatic field produced in the plasma by the foregoing charge gradient. One can see that the electrical force 244 is significant and generally offsets the pressure force 240. Thus, the electric field produced from the charge separation is the primary ion confining force.

It will be appreciated that while the magnetic field provides an initial N f confinement mechanism for the plasma, the internally-produced electric field plays an important and substantial role in establishing a stable plasma equilibrium. The force profiles shown in FIGS. 7 and 8 and the resulting steady-state equilibrium of the plasma underscore the importance of the electric field. Such a stable equilibrium state facilitated by the electric field does not appear if the plasma is quasi-neutral. Hence, the importance of not making the quasi-neutrality assumption in designing a plasma containment device is demonstrated.

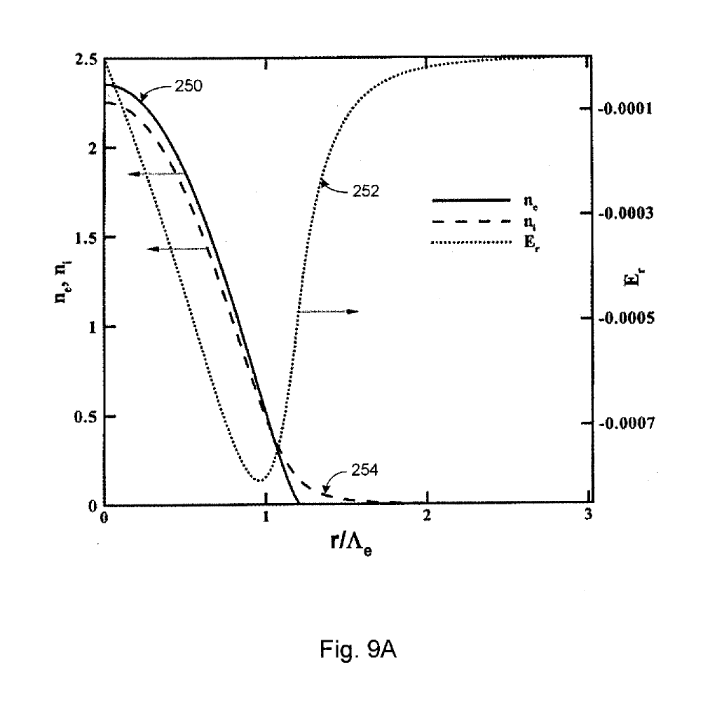

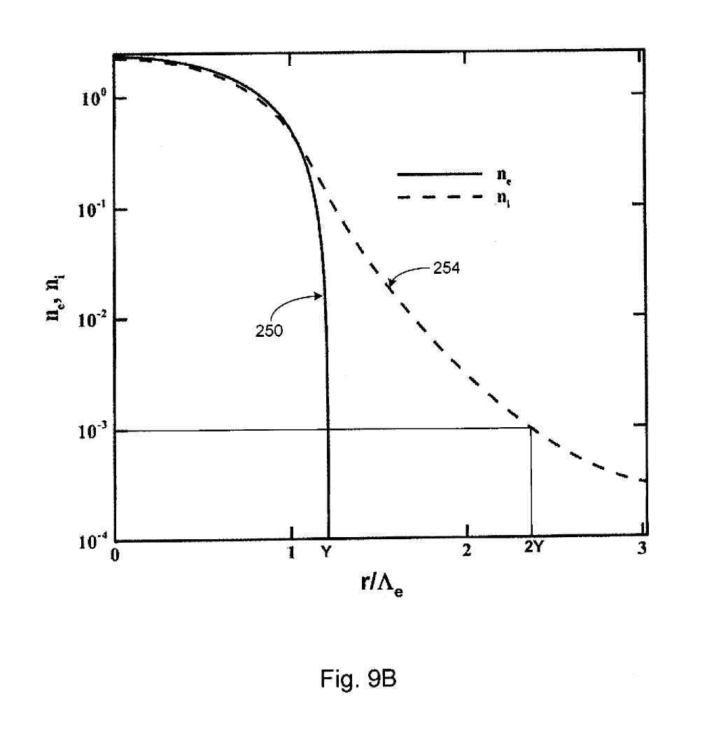

FIG. 9A now shows an electron distribution 250 and an ion distribution 254 that give rise to an electric field profile 252. The three curves 250, 252, and 254 are shown as functions of a dimensionless variable r/Λₑ. The vertical scale for the electron and ion distributions 250 and 254 is in terms of the average density value N₀. The electric field profile 252 gives rise to the electrical force profiles described above in reference to FIGS. 7 and 8. As the electron distribution 250 shows, the electrons are distributed substantially within the boundary Y at approximately 1.2Λₑ. As defined in Equation (10), the value of Λₑ=(mₑ/μₒN₀e²)^{1/2} is approximately 1.7 mm when N₀=10¹⁹/m³. Thus, the value of the electron boundary Y for the example plasma of FIG. 9A is approximately 2.04 mm.

As shown in FIG. 9A, the electron and ion distributions overlap over at least a portion of the plasma about the axis. As further shown in FIG. 9A, the electrons are substantially confined to a restricted volume defined by the electron boundary Y. Thus, such a restricted volume can be characterized by a volume scale length such as the electron skin depth Λₑ.

As further shown in FIG. 9A, the ion distribution 254 extends beyond the boundary Y. Beyond the Y boundary, the ion fluid can be characterized as satisfying single fluid equations that can easily be obtained by modifying the set of equations described above. One way to obtain a substantially complete ion distribution and its associated plasma parameter(s) is to match the two sets of equations (r<Y and r>Y) at the boundary Y by adjusting input parameters until the dependent variables and their derivatives are substantially continuous at Y.

One aspect of the present teachings relates to a plasma system having a bulk separation of charges, as shown by the electron and ion distributions 250 and 254, thereby causing formation of the radially directed electric field profile 252 that substantially overlaps with the plasma volume. Such a coverage of the produced electrostatic field can be achieved in contained plasma systems where the boundary Y for electrons has a dimension on the order of the electron scale length Λₑ.

For a system to lie within an energy well sufficiently deep to provide a robust confinement for one embodiment, the cylinder radius can lie within a range near the value of the electron scale length (skin depth) Λₑ. In the example embodiment described above in reference to FIGS. 6-9, Y≈1.2Λₑ, and the electric field extends over a substantial portion of the plasma.

A relatively large radius configuration (e.g., Y=6Λₑ) can result in a substantial electric field being produced near the outer region of the plasma cylinder. An energy well associated with such a configuration can be relatively shallow when compared to the Y≈1.2Λₑ case. Also, a relatively small radius configuration (e.g., Y=0.3Λₑ) can result in confinement being lost.

Thus in one embodiment, a plasma confinement that is facilitated by the electrostatic field has a value of Y that is in a range of approximately 1 to 2 times the electron scale length Λₑ. In one embodiment, a value of Y around 1.2Λₑ appears to provide a near optimal confinement condition. For a plasma with N₀=10¹⁹/m³ (as with the example plasma of FIGS. 6-9), Λₑ=1.7 mm, and Y=(1.2)(1.7)≈2.04 mm. Since a=3Λₑ for the example plasma, the outer radius of the contained plasma is approximately 5.1 mm. One can see that such a compact dimension of a stable, contained plasma can be used in a number of applications, some of which are described below in greater detail.

The plasma is contained such that energy and/or particle loss(es) from the plasma to a wall defining a containment volume is reduced. One way to achieve such energy/particle loss reduction is to reduce the number of plasma particles coming into contact with the wall. As shown in FIG. 9B, where the electron and ion distributions 250 and 254 are plotted on a logarithmic scale, the ion number density 254 reaches a value of approximately 0.001 N₀ when r/Λₑ is approximately twice the value of Y. Thus for an embodiment where Y=1.2Λₑ≈2.04 mm, the ion number density reaches approximately 0.1% of the average density value N₀ at r≈(2.04)(2)=4.1 mm.

As described above, for a plasma containment design where a 3Λₑ the outer radius a is approximately 5.1 mm for the Y=1.2Λₑ case. For such a system, a wall can be positioned at a location r>5.1 mm and still allow construction of a relatively small containment device. Moreover, the ion number density at r>5.1 mm (3Λₑ) is substantially lower than the 0.1% level described above. Thus, the number of ions coming into contact with the wall at r>5.1 mm and transferring energy thereto and/or interacting therewith is reduced even more.

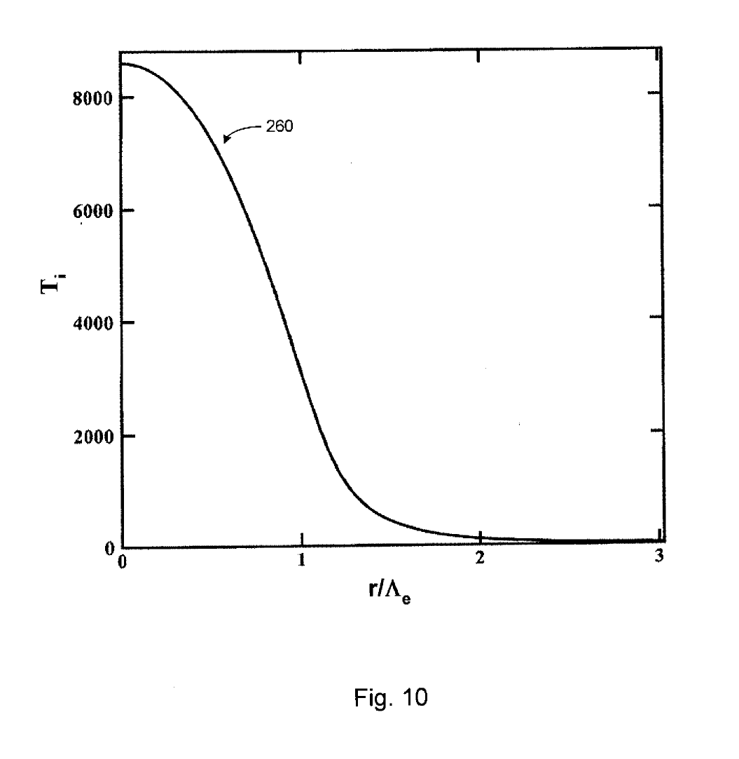

FIG. 10 shows a plasma temperature profile 260 as a function of r/Λₑ for the example plasma described above in reference to FIGS. 6-9. One can see that the temperature is reduced substantially at 3Λₑ (5.2 mm). The temperature is even lower for the region r>3Λₑ. Thus, heat transfer from the plasma to the wall located at r>3Λₑ is reduced, since the plasma particles that come into contact with the wall have substantially low kinetic energies when compared to the inner portion of the plasma.

The example plasma described above in reference to FIGS. 6-10 advantageously includes the electrostatic field. Such a plasma includes electrons distributed substantially within a boundary Y that is in a range of approximately 1-2Λₑ so as to allow the electric field to cover a substantial portion of the plasma volume. Such a significant presence of the electric field facilitates a robust containment of the plasma at a scale on the order of the electron scale length (skin depth). Investigation of such a plasma system shows that such features of the contained plasma at such a scale hold when the input parameters are varied significantly. As an example, similar advantageous electric field facilitated confinement holds within a factor of approximately 2 when the average number density N₀ changes by a factor of approximately 10 and when the input temperature value T₀ changes by a factor of approximately 30. Thus, design of a plasma containment having a dimension on the order of electron scale length can be made relatively flexible.

The present disclosure reveals substantial electric fields due to excess electrons in the r<Y region and ions being substantially the only species in the r>Y region. As described above, numerical solutions can be obtained by solving Equations (11A)-(11P) for r<Y and substituting Y for a in the boundary conditions. One can solve the modified set (for ions) for r>Y and replacing 0 by Y in the boundary conditions and then matching the solutions of the two sets at r=Y. In one embodiment, the number density of the magnetically bound species becomes substantially zero at r=Y.

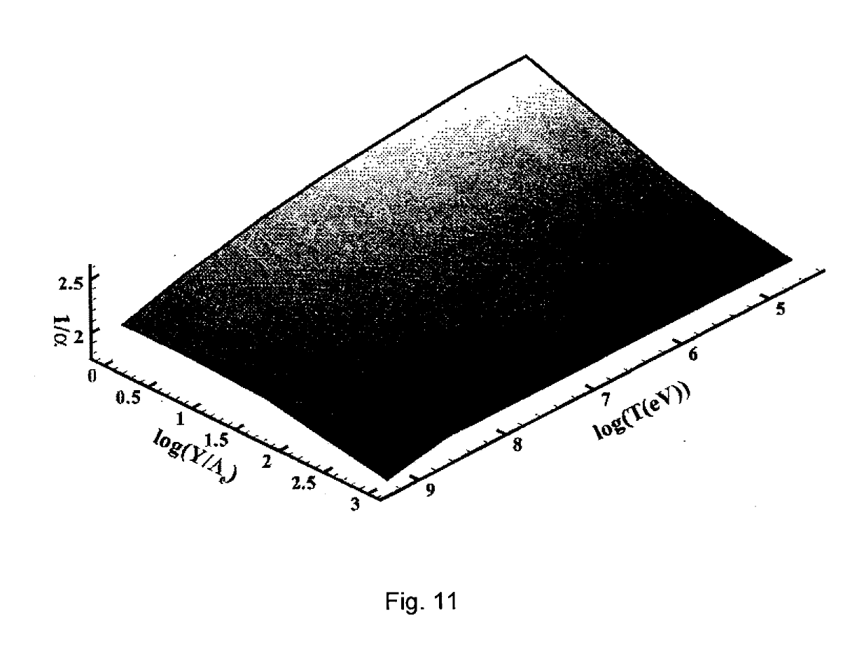

In one embodiment, accomplishing such a matching process can place an additional restriction on the input or control parameters that can be expressed in terms of 1/α and 1/β. For example, in the cylindrical coordinate treatment of the Z-pinch embodiment, 1/α, which can be obtained from N₀, T₀, and B₀, is approximately 2 (for typical fusion plasma parameter values). A more precise value of 1/α can be expressed as a slowly varying function of T₀ and n₀. For the example cylindrical geometry, an approximate value can be obtained from an example contour plot of 1/α as a function of Y/Λₑ and temperature T, such as that of FIG. 11. For a theta-pinch, screw-pinch, ions moving, other geometries, or combinations thereof, the appropriate restriction can be obtained either experimentally or by solving the equations similar to Equations (11A)-(11P) and the appropriate modified set for r>Y. In one embodiment, the number density of the current carrying species approaches approximately zero at the boundary r=Y. In one embodiment where both species can carry substantial current, similar method can be applied to obtain a solution.

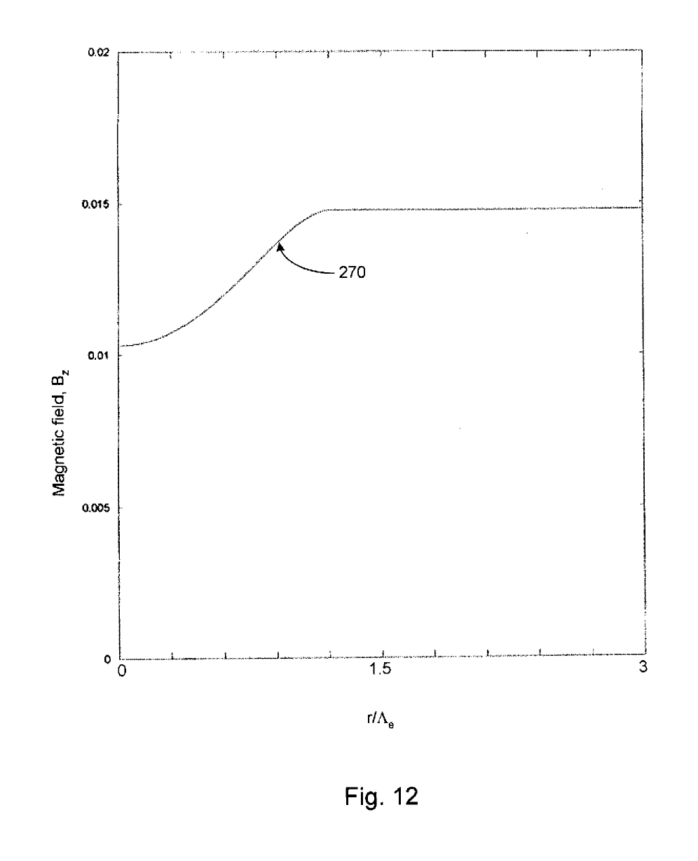

The example plasma described above in reference to FIGS. 6-10 is Z-pinched. Similar electrostatic field effects can also arise when a plasma is theta-pinched. FIGS. 12-14 show an example result of the energy variational method described above with regard to a theta pinch.

For the theta-pinch example, an outer diameter a of approximately 3Λₑ is used. Furthermore, input parameters N₀=10¹⁹/m³, T₀=10⁴ keV, 1/α=0, and 1/β=20.5 are used. The corresponding electron scale length Λₑ=(mₑ/μₒN₀e²)^{1/2} is approximately 1.7 mm.

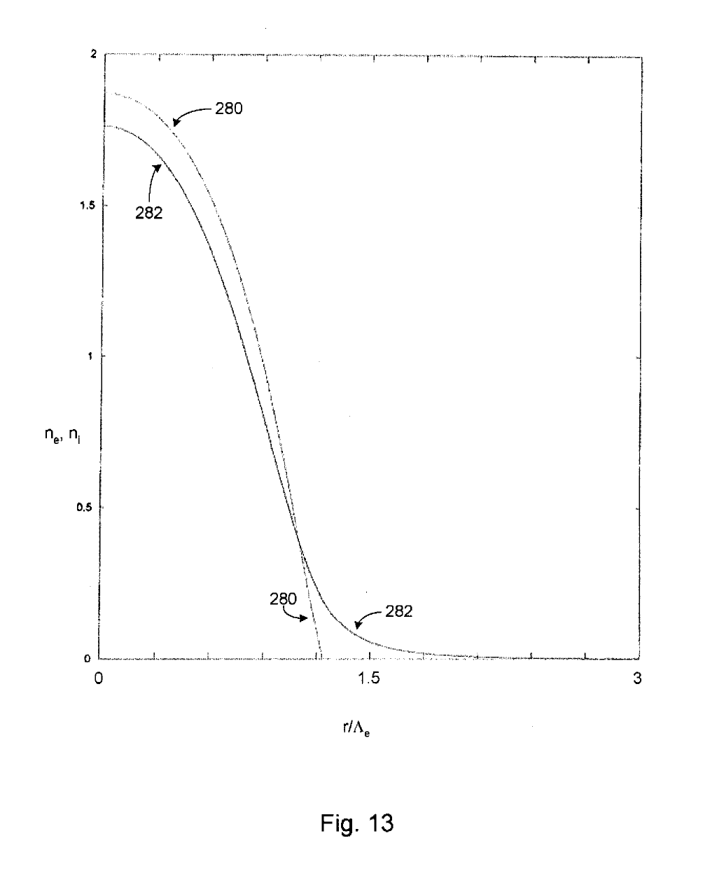

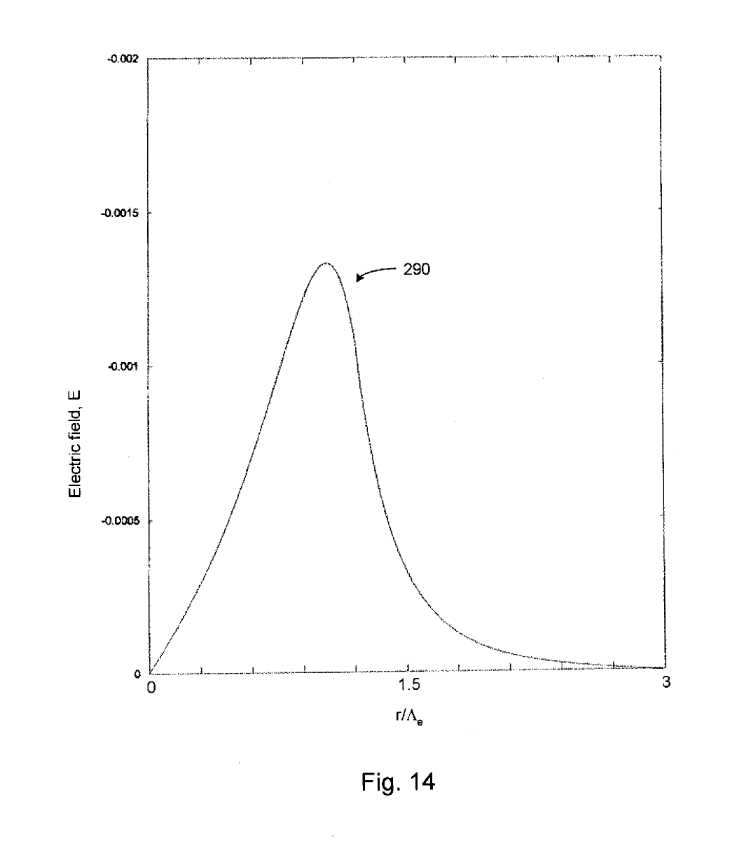

Based on the foregoing example inputs, FIG. 12 shows an axial magnetic field profile 270 as a function of distance from the Z axis. Such a magnetic field theta-pinch can confine the plasma such that an electron distribution 280 and an ion distribution 282 are formed as shown in FIG. 13. Separation of charges due to such distributions can cause a substantial electrostatic field profile 290 as shown in FIG. 14.

The foregoing example theta-pinch confinement results in the value of Y being approximately 2.04 mm. Thus, a theta-pinched plasma with a confinement dimension on the order of the electron scale length Λₑ can provide the various advantageous features described above in reference to the Z-pinched plasma system.

As previously described, a screw-pinch can be achieved by a combination of Z and theta pinches. Thus, an energy variational analysis similar to the foregoing can be performed with 1/α≠0 and 1/β≠0 to yield similar results where a substantial electrostatic field is produced by separation of charges. Furthermore, a screw-pinched plasma with a confinement dimension on the order of the electron scale length Λₑ can provide similar advantageous features described above in reference to Z and theta pinched plasma systems. Screw-pinch magnetically confined plasmas are generally regarded as more stable than simple Z- or theta-pinches. It is expected that screw-pinch embodiments of the present teachings will share the various features disclosed herein.

As also described, magnetically confining a plasma in a dimension on the order of the plasma's electron scale length results in separation of charges, thereby inducing a substantial electrostatic field over a substantial portion of the plasma volume. Such an electric field can be characterized so as to correspond to a depth of an energy well associated with a stable equilibrium. Moreover, the energy well depth is expected to be relatively deep when the electron fluid radius Y is in a range of approximately 1-2 Λₑ. Such relatively deep energy well of the equilibrium provides a relatively stable confined plasma. Such stability of a confined plasma at a value of Y of approximately 1-2 Λₑ, however, does not preclude a possibility that magnetic confinement at larger values of Y can have its stability facilitated significantly by the electrostatic field.

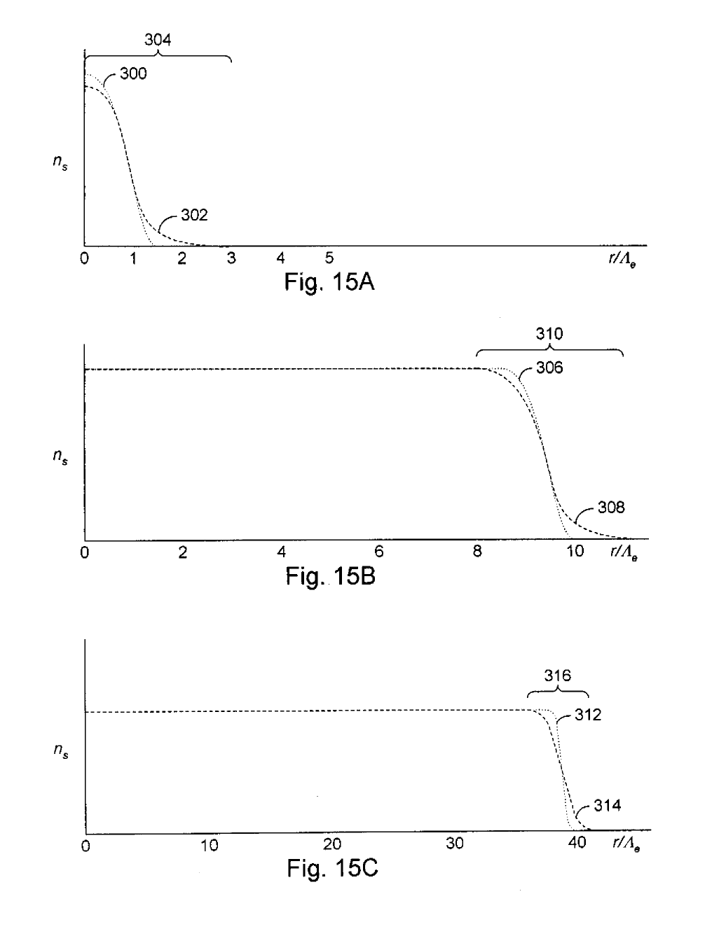

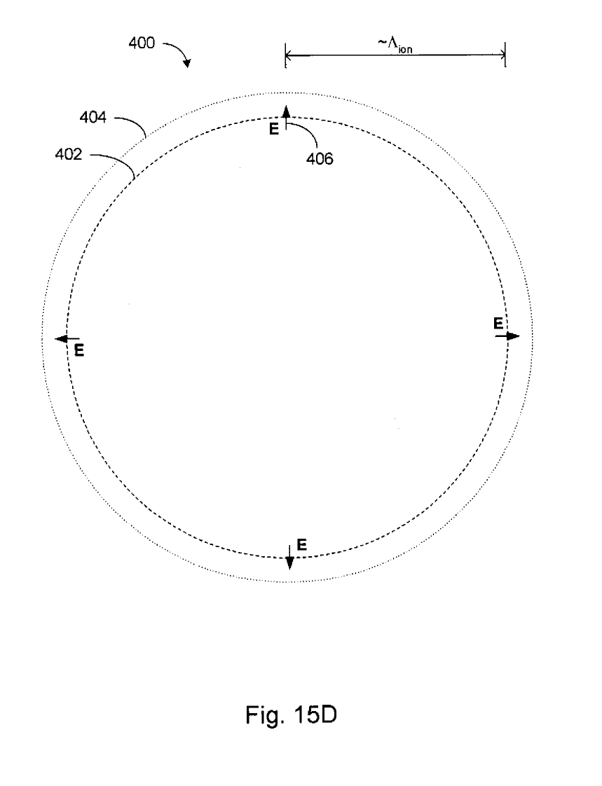

One aspect of the present teachings relates to a magnetically confined and relatively stable equilibriated plasma at different dimensional scales. FIGS. 15A-C show electron and ion distributions for different plasma sizes. While the larger sized plasma systems may not yield equilibria that are as stable as the case where Y=1-2 Λₑ, such equilibria may nevertheless have sufficient stabilities that are facilitated by the electric field.

FIG. 15A shows a first set of particle densities as a function of the dimensionless variable r/Λₑ. Curves 300 and 302 represent example electron and ion distributions. The electron distribution 300 is depicted as being substantially bounded at Y≈1.5Λₑ, and is thereby similar to the example plasma described above in reference to FIG. 9A. A resulting electrostatic field (indicated as a bracket 304) covers a substantial portion of the plasma.

FIG. 15B shows a second set of particle densities where an electron density distribution 306 is substantially bounded at an example value of Y≈10Λₑ. An ion density distribution 308 is shown to extend beyond the boundary Y, thereby inducing an electrostatic field that influences a region 310 near the outer boundary of the plasma.

FIG. 15C shows a third set of particle densities where an electron density distribution 312 is substantially bounded at an example value of Y=40Λₑ. An ion density distribution 314 is shown to extend beyond the boundary Y, thereby inducing an electrostatic field that influences a region 316 near the outer boundary of the plasma.

In various plasma embodiments, the electric field coverage scales (304, 310, 316) are generally similar, and can be on the order of few electron scale lengths. Thus, one way to characterize a role of the electrostatic field in the stability of the plasma is to consider the electric field as a layer formed near the surface of the plasma volume. In systems where a plasma volume dimension (e.g., radius a in cylindrical systems) is on the order of the E-field layer “thickness” (such as the system of FIG. 15A), the influence of the electrostatic field is substantial with respect to the overall plasma. Consequently, an energy stability facilitated by the electrostatic field can be more pronounced in such systems.

In systems where a plasma volume dimension is substantially larger than the E-field layer “thickness” (such as the systems of FIGS. 15B and C), the influence of the electrostatic field may not be as substantial when compared to systems such as that of FIG. 15A. Consequently, electrostatic fields can provide significant contributions to energy stability; however, such contributions are typically not expected to be as pronounced as that of a smaller system.

One aspect of the present teachings relates to a plasma having a substantially larger scale length (skin depth) than that of plasmas where the electrostatic field is on the order of an electron scale length (electron skin depth). FIG. 15D shows an example plasma 400 having an ion distribution bounded at an inner boundary 402 and an electron distribution bounded at an outer boundary 404, thereby inducing an electrostatic field 406 that points radially outward. One can see that in such a plasma, roles of the electrons and ions are reversed from the electron mode of operation.

In such a role-reversed plasma, ions act as charge carriers, thereby being subject to magnetic confinement. The value of a for the ions-moving plasma would be many times that for the electrons-moving plasma because of the much larger ion skin depth Λᵢₒₙ=(mᵢₒₙ/μₒN₀e²)^{1/2}. For plasmas having a similar average density value, the ratio of Λᵢₒₙ/Λₑ=(mᵢₒₙ/mₑ)^{1/2}. For deuterium, the ratio Λᵢₒₙ/Λₑ is approximately 61. Thus, a plasma having moving ions would have a volume of approximately 61²=3700 times that of the similar electrons-moving plasma, all else being substantially the same. The energy variational method described herein can be modified readily for analysis, and a resulting plasma system likely would be sufficiently large to allow power production.

As described above in connection with FIGS. 1-15, the electrostatic field can form in a plasma having a wide range of volume scale length. For a plasma where the electrons are magnetically confined, the volume scale length can be represented by the electron confinement dimension Y. In one embodiment, the volume scale length can range from approximately 1 Λₑ to approximately 1000 Λₑ. In one embodiment, the volume scale length can range from approximately 1 Λₑ to approximately 100 Λₑ. In one embodiment, the volume scale length can range from approximately 1 Λₑ to approximately 60 Λₑ. In one embodiment, the volume scale length can range from approximately 1 Λₑ to approximately 40 Λₑ. In one embodiment, the volume scale length can range from approximately 1 Λₑ to approximately 10 Λₑ. In one embodiment, the volume scale length can range from approximately 1 Λₑ to approximately 2 Λₑ. Similar volume scale length characterization can be applied to the plasma where the ions are confined.

As described above in connection with FIGS. 1-15, the electrostatic field formed in the plasma facilitates formation of a stable plasma state. In particular, the electrostatic field comprises a radially directed field. Radial electric fields are known to exist in large systems such as tokamaks. However, such radial fields are not due to the significant separation of the charges. Rather, such radial fields are the result of imbalances in the ion Lorentz and ion pressure forces, and the field magnitudes appear to be significantly smaller than the magnitudes of the static electric field (by charge separation) of the present invention.

As described above in connection with FIGS. 1-15, electrostatic field-facilitated stable plasma can be formed by magnetic confinement of electrons or ions. In such configurations, the magnetically confined particles act as charge carriers. Thus, when electrons act as charge carriers, electrons are magnetically confined; when ions act as charge carriers, ions are magnetically confined.

Being a charge carrier in the plasma can be characterized in different ways. One way is to say that charge carriers cause a current in the plasma. Another way is to say that charge carriers undergo a bulk motion in the plasma. Yet another way is to say that charge carriers flow in the plasma.

In one embodiment, both the electrons and the ions can act as charge carriers. That is, both the electrons and the ions can contribute to the current, undergo bulk motions, and flow in the plasma. A difference in the degrees of a current-producing characteristic of the two species can give rise to one species being confined magnetically more than the other. Such a difference in the magnetic confinements of the two species can produce a charge separation that causes formation of an electrostatic field in the plasma.

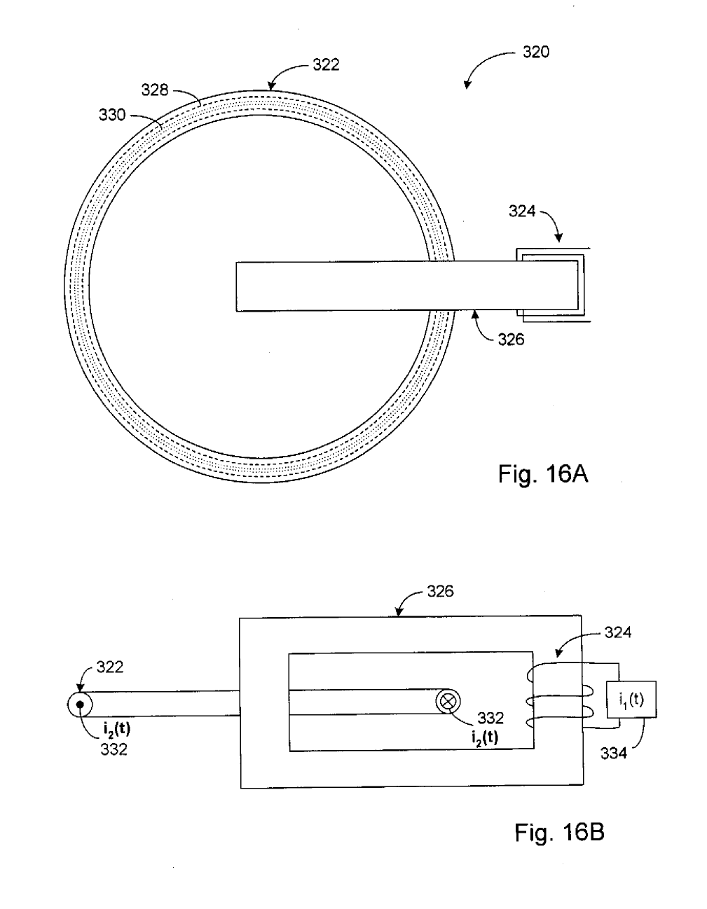

FIGS. 16 and 17 now show simplified diagrams of plasma containment devices that can magnetically contain a plasma having the substantial electrostatic field therein. FIGS. 16A and B show a simplified Z-pinch device 320 having a containment ring 322 magnetically coupled to a primary winding 324 via a transformer core 326. Charge carriers in the ring 322 act as a secondary winding on the transformer core 326, such that a primary current i₁(t) established in the primary winding 324 (via a power supply 334) induces a secondary current i₂(t) 332 within the ring 322. Such a toroidal current (an axial current in the cylindrical approximation) confines the plasma as described above in reference to FIG. 4A. Appropriately selected dimension of the ring 322 and appropriately selected parameters for plasma therein results in the separation of an electron density distribution 330 from an ion density distribution 328, thereby inducing the substantial electrostatic field.

FIGS. 17A and 17B show a simplified theta-pinch device 340 having a containment section 342 with a winding 344 thereabout. A current i(t) can be generated by a power supply 346 and be passed through the winding 344, thereby forming an axial magnetic field B_{Z} 352 (toroidal field in a toroidal system). As described above in reference to FIG. 4B, such a magnetic field can confine the plasma via a theta-pinch. Appropriately selected dimension of the confinement section 342 and appropriately selected parameters for plasma therein can result in the separation of an electron density distribution 350 from an ion density distribution 348, thereby inducing the substantial electrostatic field. The total magnetic field B_{Z} 352 is due to the sum of the current in the plasma I_{θ} 186 (FIG. 4B) and the current in the external winding 344 (FIG. 17B). These currents are oppositely directed with the field contribution due to the winding 344 dominating.

As previously described, the Z- and theta-pinches can be combined to yield a screw-pinch. Thus, the Z and theta pinch devices of FIGS. 16 and 17 can be combined to yield a screw-pinch device. Furthermore, such confinement methods and various concepts disclosed herein can be implemented in any containment devices having a confinement section that can be approximated by a cylindrical geometry.

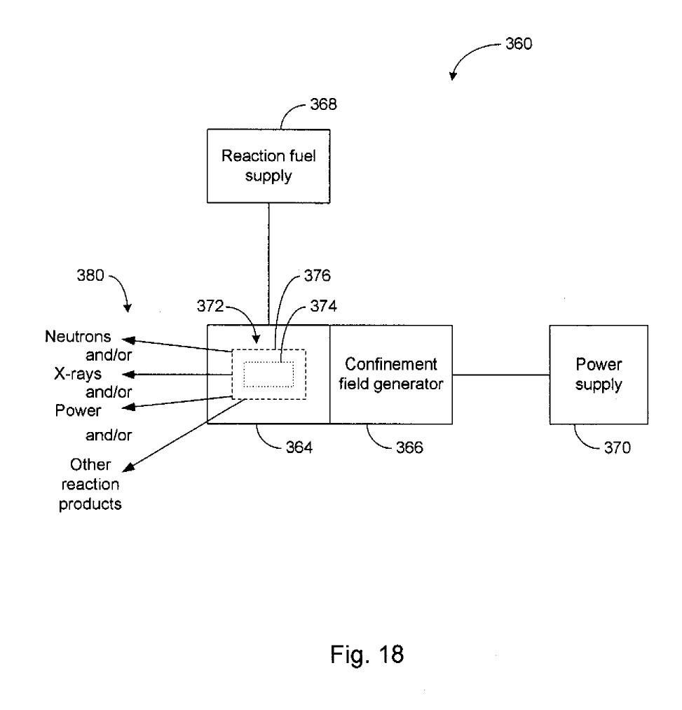

FIG. 18 shows one embodiment of a fusion reaction apparatus 360 that can be based on a contained plasma of the present teachings. The reaction apparatus 360 includes a reaction chamber 364 that includes a magnetic field that confines a plasma 372 substantially within the reaction chamber 364. Such a magnetic field can be generated by a confinement field generator component 366 that is electromagnetically coupled to the plasma 372. The field generator component 366 is powered by a power supply 370. The reaction apparatus 360 further includes a reaction fuel supply that provides and/or maintains a reaction fuel for the plasma 372.

As shown in FIG. 18, the plasma 372 embodies an electron distribution 374 that is at least partially separated from an ion distribution 376. Such a contained plasma allows at least the reaction chamber 364 to have a relatively small dimension as described above. As mentioned, the ion and electron distributions may be reversed in ion mode.

The plasma 372 contained in the foregoing manner can undergo a nuclear fusion reaction that can yield neutrons, x-rays, power, and/or other reaction products. Some of the possible reaction configurations and products for an example deuterium-tritium (DT) reaction at various example operating conditions are summarized in Tables 1-3.

Table 1 summarizes various dimensions associated with an electron-scaled high aspect ratio toroidal system at various particle densities. Quantities associated with Table 1 are defined as follows: n=average particle density; Λ=electron scale length; Y=electron fluid boundary radius=set to 1.5Λ; a=toroid's minor radius=ion fluid boundary radius=set to 2.5Y; R=toroid's major radius=set to 20a; V=toroid's volume=2π²Ra².

TABLE 1

| | n(m⁻³) | | | | |
|---|---|---|---|---|---|
| | 1.00 × 10¹⁹ | 1.00 × 10²⁰ | 1.00 × 10²¹ | 1.00 × 10²² | 1.00 × 10²³ |
| Λ (cm) | 1.68 × 10⁻¹ | 5.32 × 10⁻² | 1.68 × 10⁻² | 5.32 × 10⁻³ | 1.68 × 10⁻³ |
| Y (cm) | 2.52 × 10⁻¹ | 7.98 × 10⁻² | 2.52 × 10⁻² | 7.98 × 10⁻² | 2.52 × 10⁻² |
| a (cm) | 6.31 × 10⁻¹ | 2.00 × 10⁻¹ | 6.31 × 10⁻² | 2.00 × 10⁻² | 6.31 × 10⁻³ |
| R (cm) | 1.26 × 10¹ | 3.99 × 10⁰ | 1.26 × 10⁰ | 3.99 × 10⁻¹ | 1.26 × 10⁻¹ |
| V (cm³) | 9.90 × 10¹ | 3.13 × 10⁰ | 9.90 × 10⁻² | 3.13 × 10⁻³ | 9.90 × 10⁻⁵ |

Table 2 summarizes various neutron production rate estimates with the system of Table 1 at various temperatures. Quantities associated with Table 2 are defined as follows: T=plasma temperature; σν=reaction rate; neutron rate=n²(σν)V/4. These reaction rate and neutron rate expressions are well known in the art.

TABLE 2

| | σν | Neutron rate (s⁻¹) | | | | |
|---|---|---|---|---|---|---|
| (keV) | (cm³/s) | n = 10¹⁹ m⁻³ | n = 10²⁰ m⁻³ | n = 10²¹ m⁻³ | n = 10²² m⁻³ | n = 10²³ m⁻³ |
| 1 | 5.50 × 10⁻²¹ | 1.36 × 10⁷ | 4.30 × 10⁷ | 1.36 × 10⁸ | 1.36 × 10⁸ | 1.36 × 10⁹ |
| 2 | 2.60 × 10⁻¹⁹ | 6.44 × 10⁸ | 2.03 × 10⁹ | 6.44 × 10⁹ | 2.03 × 10¹⁰ | 6.44 × 10¹⁰ |
| 5 | 1.30 × 10⁻¹⁷ | 3.22 × 10¹⁰ | 1.02 × 10¹¹ | 3.22 × 10¹¹ | 1.02 × 10¹² | 3.22 × 10¹² |
| 10 | 1.10 × 10⁻¹⁶ | 2.72 × 10¹¹ | 8.61 × 10¹¹ | 2.72 × 10¹² | 8.61 × 10¹² | 2.72 × 10¹³ |
| 20 | 4.20 × 10⁻¹⁶ | 1.04 × 10¹² | 3.29 × 10¹² | 1.04 × 10¹³ | 3.29 × 10¹³ | 1.04 × 10¹⁴ |
| 50 | 8.70 × 10⁻¹⁶ | 2.15 × 10¹² | 6.81 × 10¹² | 2.15 × 10¹³ | 6.81 × 10¹³ | 2.15 × 10¹⁴ |
| 100 | 8.50 × 10⁻¹⁶ | 2.10 × 10¹² | 6.65 × 10¹² | 2.10 × 10¹³ | 6.65 × 10¹³ | 2.10 × 10¹⁴ |

Table 3 summarizes various power production estimates with the system of Table 1 at various temperatures for a deuterium-tritium device. Quantities associated with Table 3 are defined as follows: T=plasma temperature; power associated with charged particles=(n_{D}n_{T}σν)(5.6×10⁻¹³) (Watts). The power expression is well known in the art.

TABLE 3

| | Power (W) | | | | |
|---|---|---|---|---|---|
| T (keV) | n = 10¹⁹ m⁻³ | n = 10²⁰ m⁻³ | n = 10²¹ m⁻³ | n = 10²² m⁻³ | n = 10²³ m⁻³ |
| 1 | 7.62 × 10⁻⁶ | 2.41 × 10⁻⁵ | 7.62 × 10⁻⁵ | 2.41 × 10⁻⁴ | 7.62 × 10⁻⁴ |
| 2 | 3.60 × 10⁻⁴ | 1.14 × 10⁻³ | 3.60 × 10⁻³ | 1.14 × 10⁻² | 3.60 × 10⁻² |
| 5 | 1.80 × 10⁻² | 5.70 × 10⁻² | 1.80 × 10⁻¹ | 5.70 × 10⁻¹ | 1.80 × 10⁰ |
| 10 | 1.52 × 10⁻¹ | 4.82 × 10⁻¹ | 1.52 × 10⁰ | 4.82 × 10⁰ | 1.52 × 10¹ |
| 20 | 5.82 × 10⁻¹ | 1.84 × 10⁰ | 5.82 × 10⁰ | 1.84 × 10¹ | 5.82 × 10¹ |
| 50 | 1.21 × 10⁰ | 3.81 × 10⁰ | 1.21 × 10¹ | 3.81 × 10¹ | 1.21 × 10² |
| 100 | 1.18 × 10⁰ | 3.72 × 10⁰ | 1.18 × 10¹ | 3.72 × 10¹ | 1.18 × 10² |

As an example from Tables 1-3, not to be construed as limiting in any manner, consider a plasma system having a DT fuel confined in a high aspect ratio toroidal chamber. An average number density n of approximately 10²⁰ m⁻³, which could arise in later stages of plasma compression (discussed below), corresponds to an electron scale length Λ of approximately 0.0532 cm. Setting Y=1.5Λₑ=0.080 cm, the minor radius a at 2.5 Λₑ=0.20 cm, the major radius R at 20a=4 cm results in a volume V of approximately 3.13 cm³.

Operating such a plasma at a temperature of approximately 5 keV (where the reaction rate is approximately 1.30×10⁻¹⁷) can yield approximately 1.02×10¹¹ neutrons per second. Neutron fluxes of such an order in such a compact device are useful in many areas such as antiterrorist materials detection, well logging, underground water monitoring, radioactive isotope production, and other applications.

Operation of such a DT-fueled plasma can also yield high intensity soft x-rays having energies in a range of approximately 1-5 keV. Such x-rays from such compact device are useful in areas such as photolithography. In one embodiment, the soft x-rays are produced from the plasma even if fusion does not occur.

From Tables 1-3, one can see that the example operating parameters of 10²⁰ m⁻³ average number density at temperature of 5 keV yields a power output of approximately 57 mW. Power output can be increased dramatically by varying different plasma parameters. As previously described, the example plasma solution in reference to FIGS. 6-10 are thought to generally hold when the average number density changes by a factor of approximately 10 and when the temperature changes by a factor of approximately 30.

As a relatively conservative estimate for a possible power increase, a change in temperature by a factor of approximately 20 yields a plasma temperature of approximately 100 keV, where power output is approximately 3.72 W when n=10²⁰ m⁻³. Additionally, as described above in connection with FIGS. 15A-C, electrostatic field facilitated stable plasmas can be formed with an increased volume. Thus, scaling both major and minor radii of the high aspect ratio toroid by a factor of 10 increases the volume by a factor of 10³. Thus, because the power output is proportional to the volume of the plasma, the foregoing example 3.72 W output device can be scaled so as to produce several kilo-Watts of power. Such a device has a major radius of approximately 40 cm, which is still a relatively compact device for a power generator.

Various example plasma devices described herein can be operated by including one embodiment of an example start-up process that facilitates formation of a stable and confined plasma. The example start-up process is described in context of a plasma device having a toroidal geometry where both toroidal (axial) and poloidal (azimuthal) magnetic fields play a substantial role in confinement. A similar start-up process generally applies to the Z, theta and screw pinch concepts described herein.

In one embodiment, a vacuum toroidal magnetic field is established by current-carrying toroidal field coils wound in the poloidal direction (such as that shown in FIGS. 17A and B). Next, neutral gas is puffed into the vacuum chamber and a forced breakdown ionizes the gas yielding a relatively cold and substantially neutral plasma. In a time short compared to the recombination time of electrons and ions, the current in the primary winding of a transformer (such as that shown in FIGS. 16A and B) is ramped up. A change in magnetic flux through the central portion of the torus induces a toroidal (axial) current which produces a poloidal (azimuthal) magnetic field. This current can cause resistive Joule heating of the plasma in a small machine to 100 eV or higher.

The foregoing example start-up process can bring the plasma into a parameter regime of substantial densities and temperatures that characterize the plasma environment. Subsequently, the plasma proceeds toward a stable, confined equilibrium configuration via relaxation processes with the concomitant development of a substantial, radial electrostatic field that provides confinement for the ions. Additional heating mechanisms such as radio frequency heating can be used to further increase the plasma temperature and hence the probability of fusion events occurring in the plasma environment.

The schematic flow chart diagram that follows, as well as any preceding flow chart diagrams, are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The steps themselves may occur rapidly or over a longer period of time, and may be referred to as time periods.

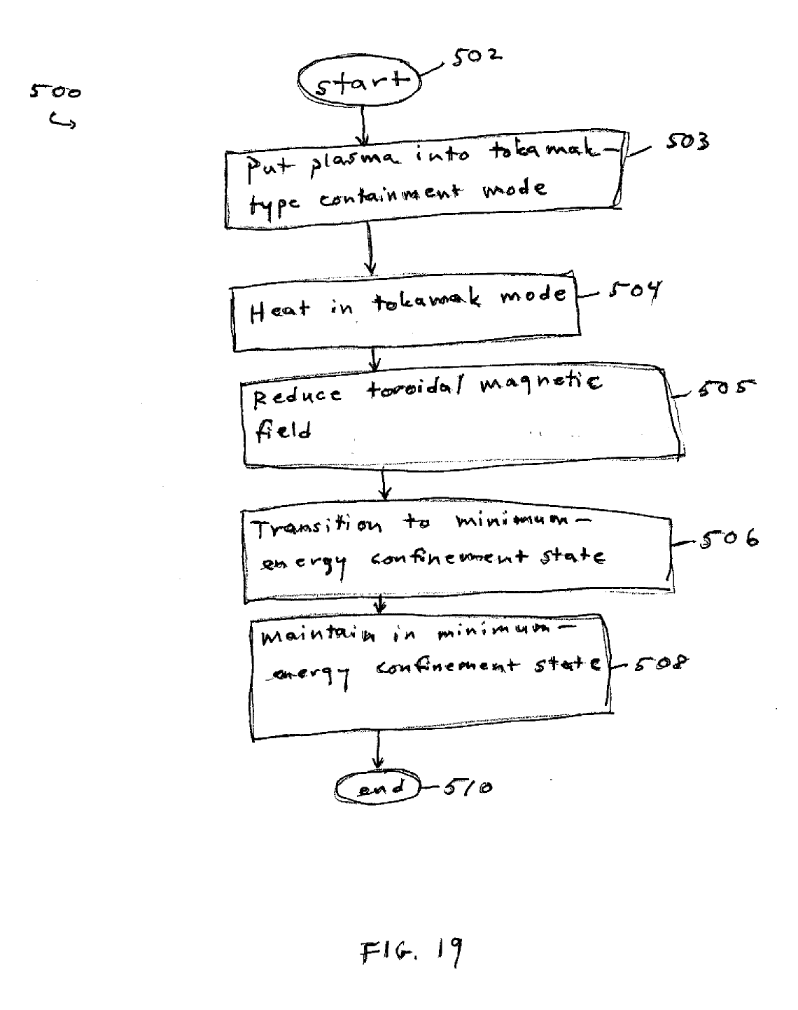

Referring now to FIG. 19, one embodiment of a method 500 by which a plasma in a containment chamber can be heated from ambient (i.e., room) temperature to high temperatures and thereafter be caused to relax into the minimum-energy equilibrium is now described.

The principle of the minimum-energy equilibrium holds for many different geometries (e.g., toroidal, such as in a tokamak, linear, such as in a Z pinch, etc.) and the method for heating the plasma may vary from one embodiment to another. The method 500 described here is one embodiment of a method that may be used with the toroidal version.

As is known, all of the many toroidal plasma containment systems known in the art provide a method for raising the plasma temperature. Some of them (e.g., a reversed field pinch) are not initially in their final containment state, but relax to that state after a period of heating. For example, during the initial heating period the reversed field pinch develops magnetic instabilities that actually enhance the relaxation process by which the final containment state is achieved.

In the method 500, the method begins in block 502, the plasma is created from a gas and put into tokamak containment mode, block 503, and the plasma is heated while in the tokamak mode, block 504, tokamak-type plasma containment being well known in the art. After the heating period of block 504 the toroidal magnetic field is reduced, block 505, and there is a rapid transition to the final minimum-energy confinement state of the present invention, block 506, and the plasma is maintained in that state, block 508, with heating continuing. When a plasma makes the transition to the final containment state, we may refer to it as relaxing to the new state. The method 500 ends in block 510.

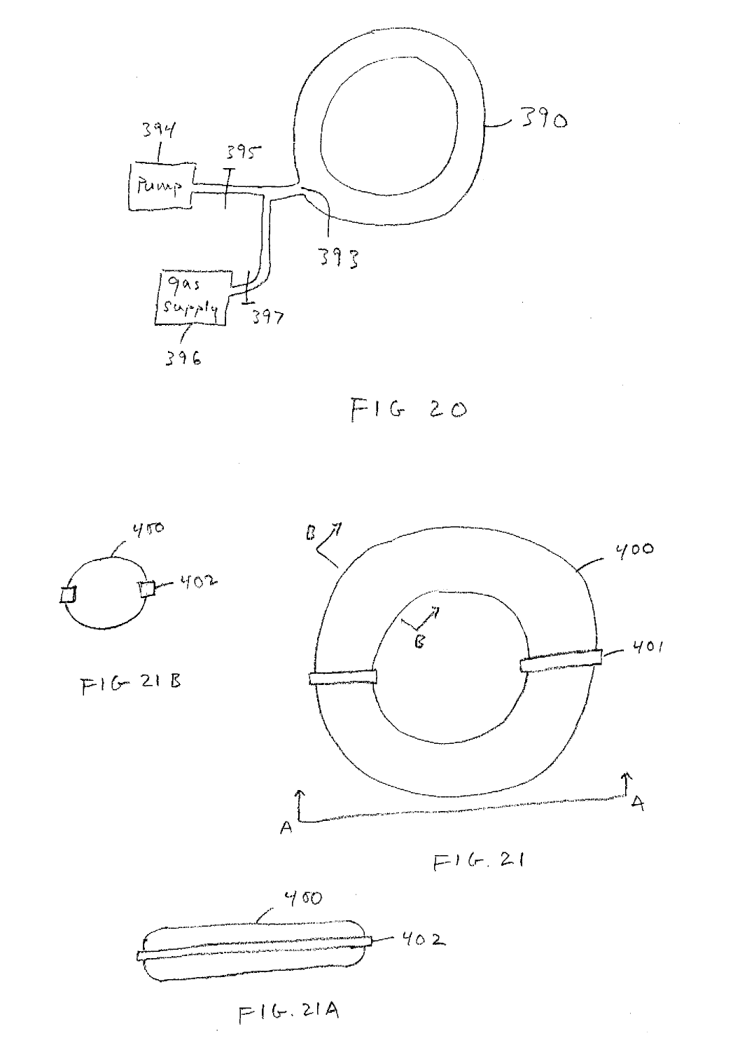

FIG. 20 shows an embodiment of a toroidal vacuum chamber 390, which may correspond to the containment ring 322 of FIG. 16 and the containment section 342 of FIG. 17. The chamber 390 is substantially toroidal in shape and is composed of an insulating material such as pyrex in order that an externally produced electric field can penetrate through the wall to a plasma disposed in the chamber 390.

FIG. 21 is a second embodiment of a toroidal containment chamber 400, which is composed generally of a conducting material such as stainless steel for improved mechanical strength. To drive current in a plasma contained in the chamber 400, a substantially toroidally-directed electric field Eₜ (not shown), should be provided. The electric field may be generated through time-changing magnetic fields which may arise from the transformer action described above in connection with FIG. 16. Alternatively, a solenoid or other apparatus may supply the time-changing magnetic field.

In order for Eₜ to appear within the plasma itself rather than in the conducting wall of the chamber 400, insulating breaks 401 (in poloidal orientation) and 402 (in toroidal orientation) are provided. These separate the chamber into four conducting pieces so that there is no complete conducting path for either poloidal or toroidal current to flow within the wall of the chamber 400. Under some circumstances, if these breaks are not present, the external, transformer-type magnetic fields may only drive currents within the conducting chamber wall rather than in the plasma contained therein.

The poloidally oriented breaks 401 keep toroidal current from flowing in the wall of the chamber 400 whereas the toroidally oriented breaks 402 stop poloidal current in the wall.

A third embodiment is also possible and has sometimes been used in toroidal magnetic containment. As is known, in that case the containment chamber is conducting, but has no insulating breaks. Under some circumstances, induction of electric fields in this embodiment, though somewhat less efficient, is not reduced sufficiently to hamper the operation of the machine. An advantage of this embodiment is that a conducting wall with complete toroidal and poloidal current paths may tend to suppress certain instabilities.

Referencing step 503 of the method 500, to put the plasma into the tokamak-type containment state in the chamber 390 (a similar process is used with regard to the chamber 400), one or more vacuum ports 393 is provided on the chamber wall to which a vacuum pump 394 and gas supply 396 are connected via valves 395 and 397, respectively. With the valve 397 closed and the valve 395 open, the pump 394 is turned on. After the chamber reaches a sufficiently low pressure (less than approximately 10⁻⁷ torr) the valve 395 is closed. This action substantially eliminates impurity gases from the chamber. The valve 397 is then opened and the desired fill gas flows into the chamber until it reaches the desired pressure, after which the valve 397 is closed. The desired pressure is determined from the minor radius a of the actual plasma toroid and the gas fill density, as described below. Any gas that is currently used in tokamak confinement, examples of which are mentioned above, may be used.

For the plasma to ultimately enter the minimum-energy equilibrium of the present invention, the gas fill density must be such that the number of particles per unit length around a high-aspect-ratio toroidal chamber such as the chamber 400 has a value within a range given by
N/l≈mπη²/(μₒe²) (13)
where N is the total number of particles per species in the chamber and l is the approximate major toroidal distance around the toroid, l=2πR, where R is the major radius of the chamber. The N/l range corresponds to the approximate range 1<η<2, which is required for robust confinement, and m is the mass of the individual charge OC) g carriers. For the electron mode of operation, m is the mass of the electron. For the ion mode of operation, where the fill gas results in a plasma consisting of an electron fluid and a single type of ion fluid, m is the mass of that ion. For fills involving more than one ion, the value of N/l lies between the extreme values for the individual ions and can be determined by solving the set of differential equations obtained by minimizing the total energy, as illustrated above with regard to a single ion. To illustrate a possible value for an electron mode of operation, using η=1.6, N/l has the value 2.3×10¹⁴/m. Typical values of N/l for other containment systems are much higher; for example, one small tokamak (STOR-1M) has N/l on the order of 10¹⁸/m, and larger tokamaks have N/l on the order of 10²⁰/m or higher.

While the fill gas density of the described embodiment is small compared to standard tokamak containment systems, later compression during the minimum-energy confinement state of the present invention will cause the plasma number density to be considerably higher than the initial fill gas density.

The right side of Equation 13 applies to other geometries as well, such that the fill gas density is approximately mπη²/(μₒe²) however that fill gas density is calculated, whether it be N/l for a high-aspect-ratio toroidal chamber or other combinations for other geometries.

Equation 13 is generated by conditions represented by the following equations:
a=ηΛ (14A)
Λ=(m/(μₒne²))^{1/2} (14B)
n=N/(πa²l) (14C)
Equation 14A was discovered computationally through the minimum-energy calculation described above, with η≈1.6. Equations 14B and 14C are definitions. The quantity n is the charge carrier density, μₒ is the permeability of free space, and e is the electronic charge.

Continuing with step 503, after filling the chamber to the appropriate density and pressure, a substantially toroidal magnetic field Bₜ (often called vacuum field) is generated within the chamber 390. In the case of the apparatus shown in FIG. 17, this may be done by causing a power supply such as the power supply 346 to provide current to the windings 344. The magnitude of Bₜ is initially large, as discussed below.

The gas is then ionized by one of several standard methods known in the art, and a short time later a toroidal electric field Eₜ is induced into the plasma by, for example, the above-mentioned transformer action described in connection with FIG. 16. This electric field drives a toroidal current—with electrons being the charge carriers in electron mode, ions in ion mode—substantially as described in connection with FIG. 16 relating to primary and secondary windings of the transformer, the secondary winding being the plasma itself. The purpose of the toroidal current is to heat the plasma and to produce a confining magnetic field.

At the moment that Eₜ is first applied, i.e., at t=0, the plasma cannot immediately reside in the minimum-energy quasi equilibrium because the driving electric field would have to be so large as to be mechanically unattainable. As a consequence, at t=0 the plasma must be confined by some means other than minimum-energy confinement. This alternate confinement continues until the plasma is heated to an intermediate temperature sufficiently high to enable it to relax into the minimum-energy state of the invention, with parameters that permit reasonable values of Eₜ for further heating.

There are substantially three time periods to note, indicated by their beginning points t₀ (=0), t₁, and t₂, the time periods corresponding to steps 504, 505/506, and 508 respectively, of the method 500.

At t₀, the driving electric field Eₜ is applied and the plasma begins to heat, with the plasma being confined by a tokamak-type containment, although, as previously noted, because of the N/l restriction in Equation 13 the plasma number density at this point will be considerably smaller than that normally used in tokamaks. The behavior during this period, i.e., step 504, is well known in the art. During the next time period t₁<t<t₂, steps 505 and 506, the plasma is caused to make a rapid transition from tokamak-type confinement to the minimum-energy confinement of the present invention. After t₂ (the time period of step 508) the plasma continues to heat with the plasma in quasi minimum-energy confinement.

Control of the plasma during the three time periods is now described. During the time period t₀<t<t₁ of step 504, the heating is substantially ohmic; i.e., the plasma current, acting against plasma resistance, heats the plasma. By means of the large toroidal magnetic field Bₜ the minor radius of the plasma is held approximately constant without significant compression or pinching, quasi neutrality is maintained, the machine is operating substantially as a tokamak, and current flow and magnetic field are substantially parallel, as is well known in tokamak operation. The equations governing the plasma during this period are
Λ×B=μₒj (15A)
and
j×B=Λp (15B)
where p is the scalar pressure and j is the net current.

The net magnetic field B has two components, Bₜ and Bₚ. In one embodiment, the primary contribution to the toroidal field Bₜ is made by the external coils 344 of FIG. 17, although there will be some contribution from poloidal current jₚ in the plasma. Poloidal fields Bₚ are produced by the toroidal component of the plasma current jₜ.

During the time period t₀<t<t₁ of step 504, the contributions to Bₜ from the external coils 344 is large. As the current jₜ increases because of the induced transformer-action electric field Eₜ, the poloidal magnetic field Bₚ produced by the plasma current grows and the total field B begins to deviate from purely toroidal to helical. A measure of the relative contributions of these two field components is called the safety factor, as is known. As expressed by Equation 15B, the poloidal magnetic field produces a force on the toroidally-moving current carriers that is in the inward radial direction and maintains an equilibrium against the outward radial force due to the plasma pressure gradient.

In the tokamak operation of step 504, the large toroidal field Bₜ is important to confinement and stability. The plasma minor radius a does not change significantly, the electron and ion volumes are the same, quasi neutrality is sustained, the electron and ion charge distributions are substantially the same, and no significant radial electric field is built up. Ions are confined to substantially the same volume as the electrons as expressed in the notion of quasi neutrality.

The purpose for the tokamak-like manner of operation during the period t₀<t<t₁ of step 504 is to enable the plasma to remain confined while achieving a temperature level and concomitant conditions (e.g., magnetic fields, beta values) such that the plasma can be caused to relax into the minimum-energy state with heating continuing at a reasonable value of Eₜ.

It is well known that large tokamaks operate well using ohmic heating up to temperatures of approximately 3 keV. Above such temperatures, auxiliary heating is necessary (a requirement that is alleviated by the present invention) and the technology required to further heat the plasma while maintaining confinement becomes complex and expensive. An example of this is the large, expensive machine ITER (International Thermonuclear Experimental Reactor).

Between t₁ and t₂, steps 505 and 506, the plasma crosses over from tokamak-type confinement to the minimum-energy quasi equilibrium state wherein the direction of the plasma bulk flow velocity v relative to B changes from substantially parallel to substantially perpendicular. At t₁, the temperature T and the magnitude of the poloidal magnetic field Bₚ will have a value such that α (=nkT2μₒ/Bₚ²) satisfies the relationship necessary for minimum-energy confinement. In the toroidal geometry of a tokamak, α is a toroidal beta value.

One embodiment of carrying out step 505 in the tokamak configuration under consideration is to, at time t₁, rapidly reduce or ramp down the external coil contribution to Bₜ by lowering the current 346 in the coil 344 of FIG. 17. This current may be driven by a capacitor bank and its time-dependent profile determined by an associated electronic circuit, as is well known in the art. The reduction continues until the magnitudes of Bₜ and Bₚ and temperature T have values such that 1/α and 1/β, the latter being the inverse of the poloidal beta value β (=nkT2μₒt/Bₜ²) in the tokamak configuration, reach values sufficient to reach the minimum-energy confinement of the present invention.

The two beta values are equivalent to, and applications to the tokamak configuration of, the beta values described earlier, i.e., α=N₀kT₀/(B_{θ}(a)²/2μ₀), and β=N₀kT₀/(B₀²/2μ₀). The notation is somewhat different but expresses the same concepts, i.e., N₀=n and T₀=T. In the tokamak configuration, B₀ is the toroidal magnetic field Bₜ, and B₀(a) is the poloidal magnetic field Bₚ.

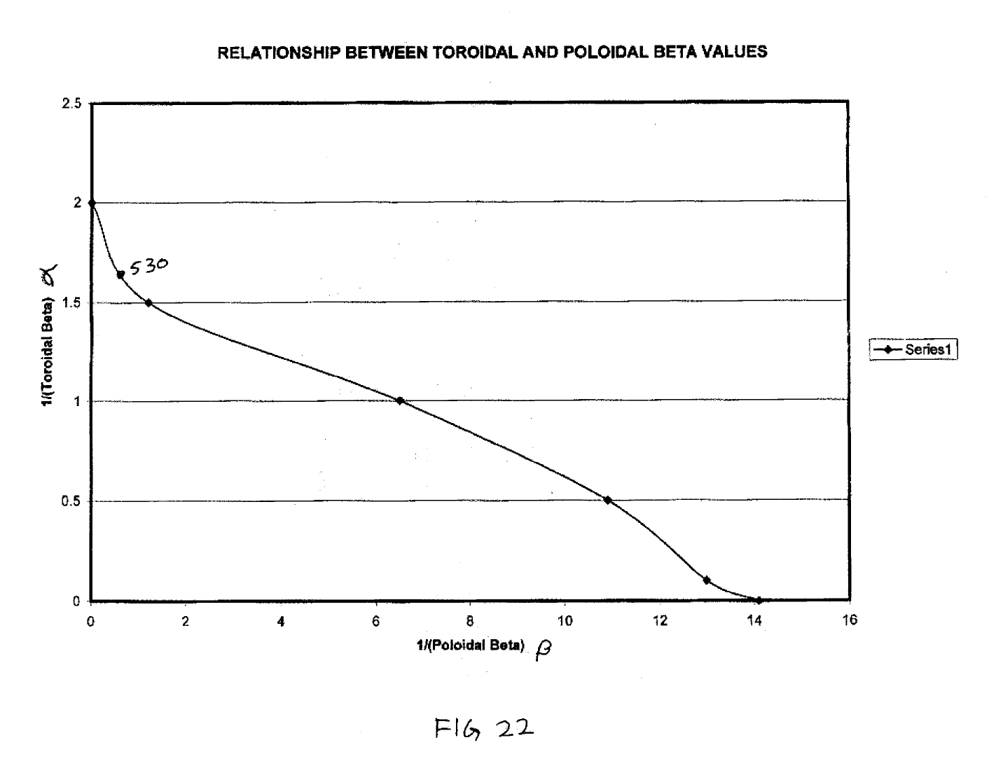

The relationship between α (toroidal beta) and β (poloidal beta) sufficient for the plasma to enter the minimum-energy state of the present invention is illustrated for a particular plasma (n=1×10¹⁹/m³, kT=100 eV, and Y=2.5 mm) in FIG. 22. This plot was obtained by repeatedly solving the minimum-energy set of differential equations using different input values of magnetic field Bₜ(a)=B₀ and toroidal current I. As seen in FIG. 22, for screw-pinch confinement that remains near a Z pinch, for example, at point 530, 1/α could be 1.7 and 1/β 0.5. This would give enough θ pinch to provide the added stability that is expected from screw pinch.

As mentioned above, FIG. 22 was obtained using particular values of n, kT, and Y. Other beta values will be obtained under different conditions, but under all conditions, 1/α expected to remain between 0 and 3 and 1/β between 0 and 30 to reach the minimum-energy state.

With the particular values mentioned, 1/α and 1/β should fall on or near the curve in FIG. 22. The controls that are available to achieve this include selection of the time t₁ to start ramping down of Bₜ, magnitude of the current in coils 344 at t₁, and current profile between t₁ and t₂, which includes the rate of change of the current. Exactly where on the curve they fall depends on how much of a Z-pinch or theta-pinch is sought.

The current jₜ and magnetic field Bₚ are already perpendicular at t₁. As a result, when the external toroidal magnetic field Bₜ, which earlier substantially controlled the system, is reduced to very low values, the angle between the total magnetic field and the current approaches 90°. As a consequence, this condition for minimum-energy equilibrium should be easily satisfied.

In an electron mode (electrons carrying the current), as Bₜ becomes small, a pinch effect from Bₚ will cause the electron flow to develop a radially inward component, the electrons will pinch, the electron containment radius will reduce, and electron containment volume will diminish. The electrons and ions separate and an inwardly directed, radial electrical field builds up to contain the ions as described by the minimum-energy equilibrium conditions.

How fast the ramping down of Bₜ can occur is controlled in part by the plasma resistance—if the plasma were a perfect conductor (zero resistance) one could not ramp down the magnetic field; the time it would take would approach infinity. This is because the resulting change of magnetic flux induces an electric field within the plasma that drives a poloidal current in the plasma (Faraday's Law) directed in such a manner as to maintain the original magnetic field Bₜ unchanged (Lenz's Law). Resistance within the plasma causes this induced poloidal current to decay and, as a consequence, allows the magnitude of Bₜ to lower. The scale time for this to occur is approximately the well-known time constant L/Ω where L is the circuit inductance and K is the equivalent circuit resistance. An estimate of this time constant is
τ=[μₒe²a²(kT)^{3/2}ln(8R/a)]/(2mκ) (16)
where the variables have their usual meanings and κ is given in connection with Equation 21.

In one embodiment, step 505 is rapid in order to avoid instabilities that are destructive to confinement. The scale time that measures the growth rate of many rapid tokamak instabilities can be estimated by dividing the plasma minor radius a=ηΛ by the Alfven velocity ν_{A}=B/(μₒmᵢₒₙn)^{1/2}. For typical values in the present illustration this is on the order of 30×10⁻⁶ s and is independent of number density. Using R=10a, a=2 cm, and kT=1 eV Eq. (o) gives τ=1.1×10⁻⁶s for the ramping-down time constant—an adequate number to avoid disruptive instabilities. Other embodiments may echo the reverse field pinch and use the instabilities to help relax to the minimum-energy state.

With regard to step 506, there is evidence, both observational (e.g., Venus flux ropes) and theoretical, that systems that are near the minimum-energy quasi equilibrium will relax to that state explosively. According to this, when Bₚ, Bₜ, T, α, β, n, and θ (the angle between the magnetic field and the flow velocity), near the values required for minimum-energy equilibrium, they will relax to the quasi equilibrium state very quickly through rapid internal adjustments of the plasma radius a, internal currents, and other parameters.

After properly ramping down Bₜ in step 505, the plasma will have the proper values of T, α, and β for the minimum-energy state. These quantities, however, represent only boundary conditions (coupled with input initial conditions) whereas the minimum-energy state specifies radial profiles of all variables. For example, T is the average temperature, α is determined by the average number density n₀, average temperature T, and toroidal current I; β is determined by n₀, T, and the boundary value of the toroidal magnetic field. None of these are actual radial profiles. Although these quantities may have the proper values for minimum-energy confinement, this, in itself, does not say that that the system is yet in the minimum-energy state, though it does indicate that it will go there in accordance with step 506. To be in the minimum-energy containment, in addition to those boundary conditions, one must have the correct profiles for all radius-dependent variables: T(r), Bₜ(r), Bₚ(r), nₑ(r), nᵢ(r), vₑ(r), vᵢ(r), and so on.

Again, even though a proper minimum-energy set of boundary conditions does not require minimum-energy profiles, it will lead to them. Device designers or operators can achieve a minimum-energy state by manipulating those quantities that are under their control in such a manner as to establish the minimum-energy-state boundary conditions. Then, through internal adjustments of internal plasma profiles, the plasma will relax to the minimum-energy state in a self-consistent manner.

As explained above, for the minimum-energy state, poloidal currents in windings 344 (FIG. 17) and poloidal currents 186 (FIG. 4B) in the plasma are oppositely directed. As a consequence of this, the diamagnetic poloidal plasma currents likely cannot be induced by means of the external windings 344. These poloidal plasma currents arise, in a self consistent manner, as a consequence of the plasma lowering its magnetic energy by reducing the total toroidal magnetic field B_{Z} (352 in FIGS. 17 and 184 in FIG. 4B). This reduction is accompanied (as required by Faraday's law and the Lorentz force equation) by internal inductive electrical forces that drive the internal plasma current 186 (as required by Ampere's law) in a self consistent manner.

When the minimum-energy set of boundary conditions is reached for a pure Z-pinch plasma (or the Z-pinch component of a screw-pinch plasma state), internal plasma variable profiles will already be near the true minimum-energy profiles and little internal relaxation of the plasma will be needed to achieve the true minimum-energy profiles. However, for a pure θ-pinch plasma (or the θ-pinch component of a screw-pinch plasma state), internal plasma variable profiles would likely be further away from the final, minimum-energy profiles. Consequently, relaxation of plasma profiles of the θ-pinch components would likely take longer than relaxation of the Z-pinch components.

According to the present invention, establishing the appropriate boundary conditions at reasonably high temperatures will produce the minimum-energy profiles. It is well-known that physical systems that are in equilibrium states having higher energy than corresponding minimum-energy equilibrium states are often unstable to small perturbations that tend to lower the energy. These instabilities rapidly (often exponentially) move the system away from higher-energy equilibria toward the lower energy states. Changes of this nature are sometimes called relaxation processes. Sometimes internal plasma resistance aids the relaxation.

After step 506—the transition to the new equilibrium state—beginning at time t₂ the driving electric field Eₜ will continue to heat the plasma, although the heating is progressively less ohmic and more compressional. The plasma system will substantially remain in the minimum-energy equilibrium with parameter adjustments tracking the heating due to Eₜ (step 508). Inasmuch as the equilibrium parameters themselves change as heating continues, the state is called quasi minimum-energy equilibrium.

As the plasma enters the minimum-energy quasi-equilibrium state the plasma increasingly will no longer be forced to maintain its minor radius a constant. Instead the plasma will compress or pinch. This compression will cause the temperature to increase, likely by many factors, over and above that produced by the ohmic heating. For temperatures exceeding a few keV, compression will be by far the primary source of heat. For the electron mode of operation, compression will heat ions even without equilibration.

We now estimate the time-dependent values of various plasma parameters including temperature T(t), number density n(t), and radius a(t) during both time periods t<t₁ (step 504) and t>t₂ (step 508). The calculations are simplified to eliminate radial dependence of the various quantities. Despite this simplification, the general behavior of the actual plasma is expected to approximately follow these results and, consequently, the calculations are adequate for device design. Small corrections to design parameters can be determined experimentally by those skilled in the art in light of this disclosure.

We assume the random velocity distributions that represent temperature are Maxwellian. Although gradients in n and T (and consequently in pressure) are necessary during both stages of heating, a reasonable estimate of the heat produced can be determined by assuming that n(r) and T(r) are constant (i.e., have no radial dependence). This assumption also negates the need to consider radial heat transport which, for our purposes, is reasonable.

For convenience we calculate the heating of the plasma in the Z pinch mode, although in actual operation stability will be enhanced through introduction of some θ pinch.

Based on the foregoing assumptions, calculations of the time-dependent behavior of plasma parameters as the plasma is being heated follow:

Consider a volume
V=πa²l (17)
where a is the minor radius of the plasma toroid, assumed for these purposes to be substantially the same for both electrons and ions and l is the length of the approximate cylindrical volume
l=2πR (18)
where R is the major radius of the toroid. Using σ to represent the conductivity of the plasma and j the current density, production of heat energy Q through resistance in volume V will be
dQ/dt=j²V/σ (19)

In a two-species plasma, the conductivity is obtained, in terms of the electron-ion collision frequency v, by
σ=ne²/(mν) (20)

An estimate of the collision frequency is
v=κn/(kT)^{3/2} (21)
where κ depends upon the slowly varying coulomb logarithm (taken to be 10) and other parameters. For purposes of this illustration we take K to be 2.9×10⁻¹¹ eV^{3/2}m³/s.

The Second Law of Thermodynamics is
dQ=dU+dW (22)
where U is the internal energy and W is the work done on the system by changes in volume. For t<t₂ there is no change in volume, hence
dW=0 (23)
however for t>t₂
dW=pdV (24)
where p is the pressure.

Internal energy is given by
U=(3/2)NkT (25)
where N is the total number of particles in the system.

Plasma pressure is, by the ideal gas law,
p=nkT (26)

The total number of particles (see Equation 14C) is
N=nV (27)
hence dV=−Ndn/n².

The magnitude of the poloidal component of the magnetic field intensity Bₚ at r=a is, from Amperes Law,
Bₚ=μₒI/(2πa) (28)
where μₒ is the permeability of free space, and the current I is given in terms of the current density, and the velocity of the charge carriers,
I=jπa² (29)
and j is expressed in terms of the velocity of the charge carriers, v,
j=nev (30)

Acceleration of the charge carriers and consequent heating is caused by the toroidal electric field E(t) that is induced through the transformer action previously discussed. This acceleration of the charge carriers also does work to increase the magnetic field and is resisted by the ohmic resistance.
mdv/dt=eE−ej/σ+[L/(2πR)]dI/dt (31)
L is the inductance of the single loop of plasma. This we estimate through
L=Rμₒln(8R/a) (32)
which neglects internal inductance.

It is convenient to indicate the radius in terms of the penetration depth or scale factor Λ. Using η to represent the proportionality factor, this gives
a=ηΛ (33)
where Λ is given as earlier in this document by
Λ=[m/(μₒne²)]^{1/2}. (34)

As discussed earlier, we define a toroidal beta value for Z-pinch operation,
α=nkT(2μₒ)/Bₚ² (35)
where Bₚ is the magnitude of the poloidal component of the magnetic field. Note that the actual plasma beta as conventionally defined requires the use of the total magnetic field rather than the poloidal component. The total magnetic field is 1/(1/α+1/β). Since these calculations are for a z-pinch configuration, β=0. See FIG. 22.

All of the foregoing equations are evident from physical laws and definitions that follow from the assumptions made concerning this simple plasma system.

For t<t₁ the plasma is in the tokamak-type mode where dW=0, a=constant, and n=constant. During this time period Equations (A) through (R) reduce to two nonlinear, first-order, ordinary differential equation for v(t) and T(t) as follows:

$$\begin{matrix}\frac{ⅆ v}{ⅆ t} = [ \frac{eE}{m} - \frac{κ {n}_{0} v}{{( kT )}^{3 / 2}} ] {( 1 + 0.5 ln ( 8 \frac{R}{a} ) )}^{- 1} & ( 36 ) \\ \frac{ⅆ ( kT )}{ⅆ t} = \frac{2 m κ {n}_{0} {v}^{2}}{3 {( kT )}^{3 / 2}} & ( 37 )\end{matrix}$$

For t>t₂ we assume that the plasma is in the minimum-energy state. In this mode the volume can change, so (G′) is used. Two restrictions on Equations (A) through (R) are required in order for the state to be minimum energy: First, as established earlier in Equations 13-14C, when the plasma is in the optimal minimum-energy state, η is a constant between 1 and 2. For convenience and to illustrate the heating characteristics, we take this constant to be 1.6. Second, as established earlier for a Z-pinch plasma in the minimum-energy quasi equilibrium, the toroidal beta value α is nearly constant (almost independent of all input and plasma parameters) at a value near ½. For convenience, and to illustrate the heating behavior, we take α=½ and β=0. These limitations effectively put this system into the quasi minimum-energy state. We assume, as noted above, that the minimum-energy equilibrium is maintained as other plasma parameters change and the plasma heats.

For the time period t>t₂, Equations 17 through 35 reduce to two nonlinear, first-order, ordinary, differential equations in two unknowns. These are:

$$\begin{matrix}ⅆ v / ⅆ t = ( eE / m - \frac{κ n {8}^{3 / 2}}{{m}^{3 / 2} {v}^{2}} ) \cdot {( 1 + 0.5 ln ( 8 R / a ) )}^{- 1} & ( 38 ) \\ ⅆ n / ⅆ t = \frac{3 n}{v} \cdot [ ( \frac{eE}{m} + \frac{κ n {8}^{3 / 2} ln ( 8 R / a )}{{m}^{3 / 2} {v}^{2}} ) \cdot ( {( 1 + 0.5 ln ( 8 R / a ) )}^{- 1} - \frac{11 \cdot {8}^{3 / 2} η n}{3 {m}^{3 / 2} {v}^{2}} ) ] & ( 39 )\end{matrix}$$

where a=η(m/μₒne²)^{1/2}.

To give an explicit illustration of the solution of these equations we supply values for e, m, κ, and take R=0.44 m and a=0.010 m. In order for the minimum-energy state to be robust we use, for both time periods, N/l=2.3×10¹⁴. This, with the assumed value of a, determines n(0) through Equations 14C and 18. We use η=1.6 and the parameters that specify the minimum-energy state for a Z-pinch plasma, 1/α=2 and 1/β=0. At v(0) the equations are solved using Mathcad for n(t) and v(t).

Using various combinations of Equations 17-35, from solutions ν(t) and n(t) we obtain T(t), B(t), n(t), and a(t). For example we determine that
(U)T(t)=mν(t)²/(8k) (40)

This gives the heating and compression of the electron fluid. We have assumed that electrons and ions equilibrate immediately and that ion temperature is the same as electron temperature, although it is clear that the temperature of the ion fluid would lag that of the electrons even though its heating during t>t₂ is primarily compressional.

Consideration of heat transport throughout the plasma is not necessary with this calculation, although in a better determination where we consider profiles n(r), v(r), etc., it would be necessary. Again, the development of the plasma should follow this calculation, more or less, and the general behavior would be as indicated.

To continue the illustration, during the tokamak period t₀<t<t₁ of step 504, we use kT₀=0.03 eV (360 K), and n₀=7.32×10¹⁷/m³. The value α=½ is achieved at to 9.4 μs. During both periods 504 and 508 we take E(t) as constant at 30 Volts/m.

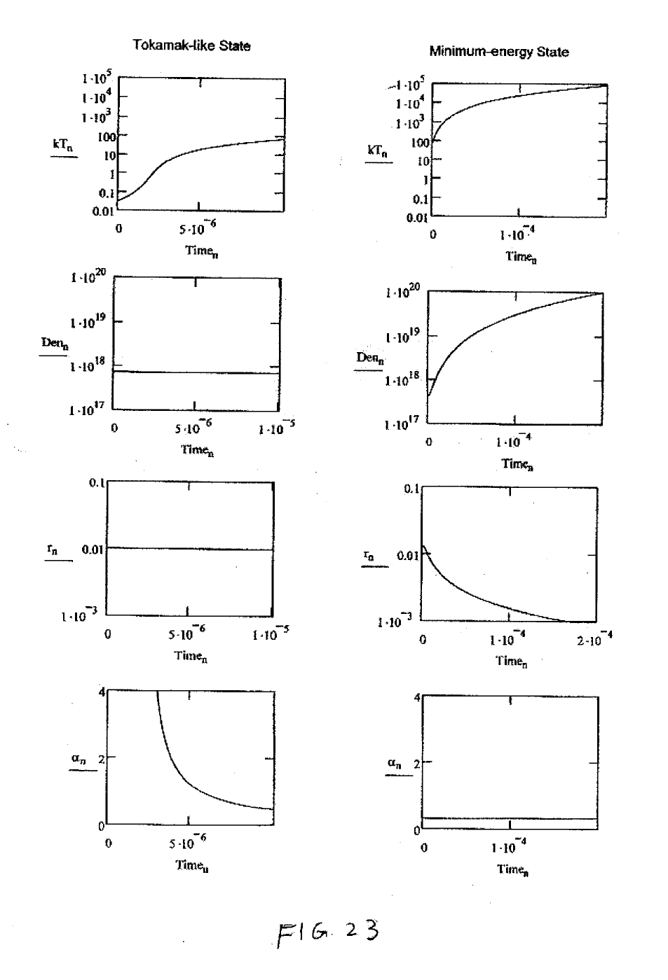

The two columns of graphs in FIG. 23 show corresponding time developments of parameters during the two periods. The first column is for the tokamak-like behavior during period 504 which brings the system up to appropriate parameter values, allowing reduction of Bₜ, step 505, and rapid relaxation into the minimum-energy state, step 506. The first row of graphs depicts temperature (eV), the second row density (per m³), the third row radius (m), and the fourth row toroidal beta value (dimensionless). One can see that α(t) reaches ½ at approximately t₁=9.4×10⁻⁶ s. The value of the number density during this period is constant at 7.3×10¹⁷/m³.

In the time region t>t₂, step 508, as shown in the second column of graphs in FIG. 23, we use kT(t₂)=62 eV and ν(t₂)=8.2×10⁶ m/s as input values for solving Equations 38 and 39. The zero of the time axis represents time t₂. During this time period the density grows to over 10²⁰ m³ and the temperature rises to over 100 keV. Most of the heating is compressional.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

What is claimed is:

1. A method of plasma containment, comprising:
providing a plasma system comprising a plurality of charged first particles and a plurality of charged second particles;
creating a dissimilarity between the overall distributions of the first and second particles.

2. The method of claim 1, further comprising inducing a bulk electrostatic field inside the plasma from the creation of the dissimilarity.

3. The method of claim 2, further comprising characterizing the total energy of the plasma system, the characterization including an electric energy term associated with the bulk electrostatic field.

4. The method of claim 3, further comprising determining an equilibrium state associated with the characterization of the total energy of the plasma system.

5. The method of claim 4, further comprising restricting the plasma to a first beta value and a second beta value, the first and second beta values depending on factors comprising average particle number density, average plasma temperature, and strength of a magnetic field established in the plasma, and wherein the inverse of the first beta value is between approximately 0 and 30 and the inverse of the second beta value is between approximately 0 and 3.

6. The method of claim 5, further comprising determining a first particle skin depth and confining the first particles within a substantially cylindrical volume of radius between 1 and 2 first particle skin depths.

7. The method of claim 5, further comprising determining a first particle skin depth and confining the first particles within a substantially toroidal volume of minor radius between 1 and 2 first particle skin depths.

8. A method of plasma containment, comprising:
providing a plasma comprising a plurality of first particles and a plurality of second particles;
confining the first particles substantially to a first volume;
confining the second particles substantially to a second volume, the second volume being larger than and encompassing the first volume.

9. The method of claim 8, wherein movement of the first particles constitutes an electric current, and wherein confining the first particles substantially to the first volume comprises establishing a magnetic field in the plasma substantially perpendicular to the direction of the current.

10. The method of claim 8, wherein confining the second particles substantially to the second volume comprises separating the bulk distributions of the first particles and the second particles such that a bulk electrostatic field is created in the plasma between the first particles and the second particles.

11. A method for plasma containment, comprising:
providing a plasma comprising a plurality of charged first particles and a plurality of charged second particles, the first particles establishing a current by acting as charge carriers in the plasma;
creating a magnetic field in the plasma, the magnetic field being oriented substantially perpendicular to the current, the magnetic field acting on the first particles to create a dissimilarity in distributions between the first particles and the second particles within the plasma.

12. The method of claim 11, wherein the first particles comprise electrons and the second particles comprise ions.

13. The method of claim 11, wherein the first particles comprise ions and the second particles comprise electrons.

14. The method of claim 11, further comprising containing the plasma within a substantially cylindrical volume, the volume defining an axial direction and an azimuthal direction.

15. The method of claim 11, further comprising containing the plasma within a substantially toroidal volume, the volume defining a toroidal direction and a poloidal direction.

16. The method of claim 14, wherein the current flows in an axial direction and the magnetic field is oriented in an azimuthal direction.

17. The method of claim 14, wherein the current flows in an azimuthal direction and the magnetic field is oriented in an axial direction.

18. The method of claim 14, wherein the current flows in a combined axial-azimuthal direction and the magnetic field is oriented in a combined azimuthal-axial direction.

19. The method of claim 14, wherein the current flows in a helical direction and the magnetic field is oriented in a helical direction.

20. A method for plasma containment, comprising:
providing a plasma comprising a plurality of charged first particles and a plurality of charged second particles, the first particles being charge carriers of a current in the plasma;
establishing a magnetic field in the plasma that electromagnetically influences the position of the first particles more than it influences the position of the second particles;
confining the first particles substantially to a first volume under the influence of the magnetic field;
maintaining at least a portion of the second particles outside the first volume.

21. The method of claim 20, wherein the position of the first particles is electromagnetically influenced through a Z pinch.

22. The method of claim 20, wherein the position of the first particles is electromagnetically influenced through a theta pinch.

23. The method of claim 20, wherein the position of the first particles is electromagnetically influenced through a screw pinch.

24. The method of claim 20, further comprising establishing a bulk electrostatic field within the plasma and confining the second particles to a second volume, the first volume being smaller than and contained within the second volume, under the influence of the bulk electrostatic field.

25. A method for plasma containment, comprising:
providing a plasma comprising a plurality of charged first particles and a plurality of second particles, the second particles being of opposite charge to the first particles;
urging the first particles in a direction such that they establish a current;
establishing a magnetic field in the plasma;
confining the first particles substantially within a first volume through a force imposed on the first particles by the magnetic field;
maintaining at least a portion of the second particles outside the first volume, thus creating a separation in the bulk distributions of the first and second particles;
establishing a bulk electrostatic field within the plasma due to the bulk distribution separation of the first and second particles;
confining the second particles substantially to a second volume, the first volume being smaller than and enclosed within the second volume, through a force imposed on the second particles by the electrostatic field.

26. A method for plasma containment, the method comprising:
placing a plasma in a tokamak containment state;
heating the plasma in the tokamak containment state;
causing the plasma to transition into a minimum-energy quasi-equilibrium state in which quasi-neutrality does not apply, such that a bulk electrostatic field is set up within the plasma.

27. The method of claim 26, wherein placing the plasma in the tokamak containment state comprises placing a gas into a toroidal chamber at a low gas density.

28. The method of claim 27, wherein the gas is placed into the toroidal chamber at a density such that N/l≈mπη²/(μₒe²), wherein η is within the approximate range of 1<η<2.

29. The method of claim 26, wherein the plasma is heated in the tokamak containment state to a temperature such that a toroidal beta value α (=nkT2μₒ/Bₚ²) attains a value sufficient to transition to the minimum-energy state.

30. The method of claim 29, wherein a attains a value such that 0<1/α<3.

31. The method of claim 29, wherein causing the plasma to transition into the minimum-energy state comprises reducing a toroidal magnetic field of the tokamak containment state to a point where a poloidal beta value β (=nkT2μₒ/Bₜ²) attains a value sufficient to transition to the minimum-energy state.

32. The method of claim 31, wherein 1 attains a value such that 0<1/β<30.

33. The method of claim 31, wherein the toroidal magnetic field is reduced rapidly enough to avoid destructive instabilities.

34. The method of claim 31, wherein the toroidal magnetic field is reduced within a time L/Ω, where L/Ω is τ=[μₒe²a²(kT)^{3/2}ln(8R/a)]/(2mκ).

35. A method of plasma containment, the method comprising:
determining minimum-energy plasma beta values α and β for a given minimum-energy plasma volume geometry, temperature, and number density;
filling a containment volume with a gas having a density of approximately mπη²/(μₒe²), where 1<η<2;
ionizing the gas to form a plasma;
placing the plasma in a state wherein the beta values are satisfied;
producing a bulk electrostatic field in the plasma through dissimilarities in bulk distribution of plasma particle species.

36. The method of claim 35, wherein the value of 1/α is between 0 and 3 and the value of 1/β is between 0 and 30.
